(19) United States
(12) Patent Application Publication
(10) Pub. No.: US 2026/0369274 A1
(43) Pub. Date: Nov. 19, 2026

(54) Systems and methods for implementing silent speech

(71) Applicant: APPLE INC., Cupertino, CA (US)

(72) Inventors: Yonatan Wexler, Tel Aviv (IL); Asaf Kagan, Herzliya (IL); Oren Amsalem, Cambridge, MA (US); Michael Doron, Cambridge, MA (US)

(21) Appl. No.: 19/734,061

(22) Filed: Jul. 8, 2026

Related U.S. Application Data
(63) Continuation of application No. PCT/IB2025/059025, filed on Sep. 8, 2025.
(60) Provisional application No. 63/692,344, filed on Sep. 9, 2024.
(60) Provisional application No. 63/843,590, filed on Jul. 14, 2025.

(51) Int. Cl. G10L 15/25; G06F 3/01; G10L 15/22

(52) U.S. Cl. CPC G10L 15/25; G06F 3/011; G10L 15/22

(57) ABSTRACT

A wearable system for facilitating silent conversations, the wearable system comprising: a housing configured to be worn on a head of an individual; at least one sensor incorporated with the housing and configured to output signals indicative of communication-related neuromuscular activity of the individual; and at least one processor configured to: receive the signals; analyze the received signals to determine substance of at least one conversation event associated with the individual; and generate at least one electronic output corresponding to the substance.

### CROSS REFERENCES TO RELATED APPLICATIONS

This application is a continuation of PCT Patent Application PCT/IB2025/059025, filed Sep. 8, 2025, which claims the benefit of priority of U.S. Provisional Patent Application No. 63/843,590, filed on Jul. 14, 2025, and U.S. Provisional Patent Application No. 63/692,344, filed on Sep. 9, 2024, all of which are incorporated herein by reference in their entirety.

### TECHNICAL FIELD

The present disclosure generally relates to the field of discerning information from facial neuromuscular activity that occurs during speech, and more particularly to ways for improving communications with other individuals and with personal assistants.

### BACKGROUND

The human brain and neural activity are complex and involve many subsystems. One of those subsystems is the facial region used by humans for communication with others. From birth, humans are trained to activate craniofacial muscles to articulate sounds. Even before full language ability evolves, babies use facial expressions, including micro-expressions, to convey deeper information about themselves. After language abilities are learned, however, speech is the main technique that humans use to communicate.

The normal process of vocalized speech uses multiple groups of muscles and nerves, from the chest and abdomen, through the throat, and up through the mouth and face. To utter a given phoneme, motor neurons activate muscle groups in the face, larynx, and mouth in preparation for propulsion of air flow out of the lungs, and these muscles continue moving during speech to create words and sentences. Without this air flow, no sounds are emitted from the mouth. Silent speech occurs when the air flow from the lungs is absent, while the muscles in the face, larynx, and mouth articulate the desired sounds or move in a manner enabling interpretation.

Some of the disclosed embodiments are directed to providing a new approach for extracting meaning from neuromuscular activity, one that detects facial skin micromovements that occur during subvocalization, such as silent speech.

### SUMMARY

Embodiments consistent with the present disclosure provide systems, methods, and devices for detection and usage of facial movements. Consistent with other disclosed embodiments, non-transitory computer-readable storage media may store program instructions, which are executed by at least one processing device and perform any of the methods described herein.

Some disclosed embodiments may include a wearable system for facilitating silent conversations, including a housing configured to be worn on a head of an individual; at least one sensor incorporated with the housing and configured to output signals indicative of communication-related neuromuscular activity of the individual; and at least one processor configured to: receive the signals; analyze the received signals to determine substance of at least one conversation event associated with the individual; and generate at least one electronic output corresponding to the substance.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a schematic illustration of a user using a first example speech detection system, consistent with some embodiments of the present disclosure.

FIG. 2A is a schematic illustration of a user using a second example speech detection system, consistent with some embodiments of the present disclosure.

FIG. 2B is a perspective view of a user using a third example speech detection system, consistent with some embodiments of the present disclosure.

FIG. 3 is a schematic illustration of a user using a fourth example speech detection system, consistent with some embodiments of the present disclosure.

FIG. 4 is a block diagram illustrating some of the components of a speech detection system and a remote processing system, consistent with some embodiments of the present disclosure.

FIGS. 5A and 5B are schematic illustrations of part of the speech detection system as it detects facial skin micromovements, consistent with some embodiments of the present disclosure.

FIG. 6 is a schematic illustration of a reflection image associated with light reflections received from an area of facial region associated with a single spot, consistent with some embodiments of the present disclosure.

FIG. 7 is a block diagram of a memory consistent with the disclosed embodiments.

FIG. 8 is an illustration of two example use cases for interpreting facial skin movements from light reflections, consistent with some embodiments of the present disclosure.

FIG. 9 is an illustration of another example use case for interpreting facial skin movements from light reflections, consistent with some embodiments of the present disclosure.

FIG. 10 is an annotated perspective view of an individual wearing a wearable system for facilitating silent conversations, consistent with some embodiments of the present disclosure.

FIG. 11 is another annotated perspective view of an individual wearing a wearable system for facilitating silent conversations, consistent with some embodiments of the present disclosure.

FIG. 12 is additional annotated perspective view of two individuals conducting silent communications using wearable systems, consistent with some embodiments of the present disclosure.

FIG. 13 is a flowchart of an example process for facilitating silent conversations, consistent with embodiments of the present disclosure.

### DETAILED DESCRIPTION

The following detailed description includes references to the accompanying drawings. Wherever possible, the same reference numbers are used in the drawings and the description to refer to the same or similar parts. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Various terms used in the specification and claims may be defined or summarized differently when discussed in connection with differing disclosed embodiments. It is to be understood that the definitions, summaries and explanations of terminology in each instance apply to all instances, even when not repeated, unless the transitive definition, explanation, or summary would result in inoperability of an embodiment. It is also to be understood that once a term is defined herein, in the absence of an inherent inconsistency, that definition applies to all other uses of the term herein. Moreover, the exemplary embodiments of the figures and their description are not to be considered definitions of claim terms, but rather are non-limiting examples used to illustrate specific embodiments.

Throughout, this disclosure mentions “embodiments” and “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may,” and other open-ended terminology, is intended to indicate that although not every embodiment may employ the specific disclosed feature, at least one embodiment employs the specific disclosed feature.

Differing embodiments of this disclosure may involve systems, methods, and/or computer readable media containing instructions. A system refers to at least two interconnected or interrelated components or parts that work together to achieve a common objective, function, or subfunction. A method refers to at least two steps, actions, or techniques to be followed to complete a task or a subtask, to reach an objective, or to arrive at a next step. Computer-readable media containing instructions refers to any storage mechanism that contains program code instructions, for example to be executed by a computer processor. Examples of computer-readable media are further described elsewhere in this disclosure. Instructions may be written in any type of computer programming language, such as an interpretive language (e.g., scripting languages such as HTML and JavaScript), a procedural or functional language (e.g., C or Pascal that may be compiled for converting to executable code), an object-oriented programming language (e.g., Java or Python), a logical programming language (e.g., Prolog or Answer Set Programming), and/or any other programming language. Instructions executed by at least one processor may include implementing one or more program code instructions in hardware, in software (including in one or more signal processing and/or application specific integrated circuits), in firmware, or in any combination thereof, as described earlier. Causing a processor to perform operations may involve causing the processor to calculate, execute, or otherwise implement one or more arithmetic, mathematic, logic, reasoning, or inference steps.

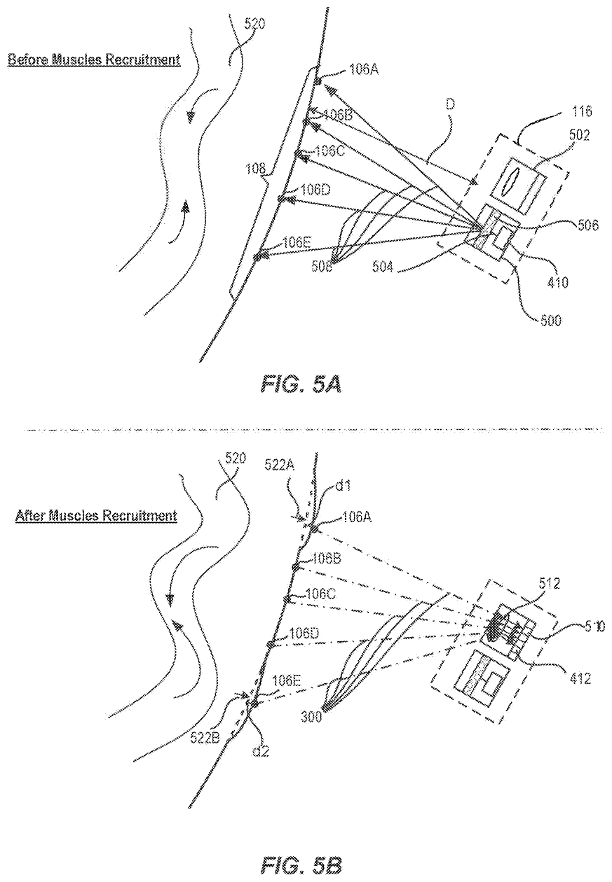

Some disclosed embodiments may involve detecting facial skin micromovements. The term “facial skin micromovements” broadly refers to skin motions on the face that may be detectable using a sensor, but which might not be readily detectable to the naked eye. The facial skin micromovements include various types of movements, including involuntary movements caused by muscle recruitments and other types of small-scale skin deformations that fall within the range of micrometers to millimeters and fractions of a second to several seconds in duration. In some cases, the facial skin micromovements are part of a larger-scale skin movement visible to the naked eye (e.g., a smile may involve many facial skin micromovements). In other cases, the facial skin micromovements are not part of any larger-scale skin movement visible to the naked eye. While such micromovements may occur over a multi-square millimeter facial area, they may occur in a surface area of the facial skin of less than one square centimeter, less than one square millimeter, less than 0.1 square millimeter, less than 0.01 square millimeter, or an even smaller area. In some embodiments, the facial skin micromovements correspond to one or more muscle recruitments in a facial region of a head of an individual. The facial region may include specific anatomical areas, for example: a part of the cheek above the mouth, a part of the cheek below the mouth, a part of the mid-jaw, a part of the cheek below the eye, a neck, a chin, and other areas associated with specific muscle recruitment that may cause facial skin micromovements. In some embodiments, the specific muscles may be connected to skin tissue and not to any bone. In particular, the specific muscles may be in a subcutaneous tissue associated with cranial nerve V or cranial nerve VII. As is discussed herein in greater detail, first facial skin micromovement 522A and second facial skin micromovement 522B in FIG. 5A and are non-limiting examples of facial skin micromovements, consistent with the present disclosure.

When specific muscles contract, the muscles pull on the facial skin and cause movements of the facial skin. Some of the movements that occur when the specific muscles contract may be micromovements. By way of example, the specific muscles that may cause facial skin micromovements in the context of the present disclosure may broadly be split into four groups: orbital, nasal, oral, and tongue. The orbital group of facial muscles contains two muscles associated with the eye socket. These muscles control the movements of the eyelids to protect the cornea from damage. They are both innervated by cranial nerve VII. The nasal group of facial muscles is associated with movements of the nose and the skin around it. There are three muscles in this group, and they are also all innervated by cranial nerve VII. The oral group is the most important group of the facial expressors: responsible for movements of the mouth and lips. Such movements are required in singing and whistling and add emphasis to vocal communication. The oral group of muscles consists of the orbicularis oris, buccinator, and various smaller muscles. In a specific embodiment, a disclosed system may monitor facial skin micromovements that correspond to recruitment of the buccinator muscle. The buccinator muscle is located between the mandible and maxilla relatively deep compared to other muscles of the face. The tongue group of muscles consists of four intrinsic muscles (e.g., the superior longitudinal muscle, the inferior longitudinal muscle, the vertical muscle, and the transverse muscle) used to change the shape of the tongue; and four extrinsic muscles (e.g., the genioglossus, the hyoglossus, the styloglossus, and the palatoglossus) used to change the position of the tongue. Any of the tongue muscles listed above may cause movements of the tongue that may be detected by analyzing detected facial skin micromovements. As is discussed herein in greater detail, muscle fiber 520 in FIGS. 5A and 5B is a non-limiting example of a facial muscle that causes micromovements of the facial skin, consistent with the present disclosure.

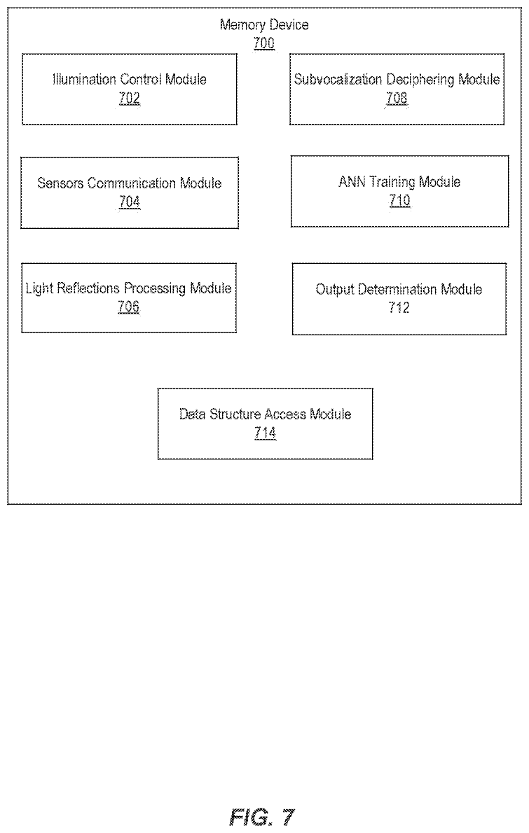

Consistent with the present disclosure, facial skin micromovements may be detected during subvocalization. The term “during subvocalization” refers to any speech-related activity that takes place without utterance, before utterance, or preceding an imperceptible utterance. In one embodiment, the speech-related activity may include silent speech (i.e., when air flow from the lungs is absent but the facial muscles articulate the desired sounds). In another embodiment, the speech-related activity may include speaking soundlessly (i.e., when some air flows from the lungs, but words are articulated in a manner that is not perceptible using an audio sensor). In yet another embodiment, the speech-related activity may include prevocalization muscle recruitments (i.e., subvocalization that occurs prior to an onset of vocalization is sometimes referred to herein as prevocalization). In some cases, the prevocalization facial skin micromovements may be triggered by voluntary muscle recruitments that occur when certain craniofacial muscles start to vocalize words. In other cases, the prevocalization facial skin micromovements may be triggered by involuntary facial muscle recruitments that the individual makes when certain craniofacial muscles prepare to vocalize words. By way of example, the involuntary facial muscle recruitments may occur between 0.1 seconds to 0.5 seconds before the actual vocalization. In some cases, a suggested system may use the detected facial skin micromovement that occurs during subvocalization to identify words that are about to be vocalized. Determining words that the user intends to say before they are actually vocalized may have many benefits because the system does not have to wait for the user to vocally articulate the words to start processing the words. In one example, a disclosed system may generate subtitles for live broadcasts without delays. In another example, a disclosed system may translate what the user is saying in real-time to a different language. Additionally, because the disclosed system can detect words before they are vocalized, the actual vocalization of these words is not a requirement. Thus, facial skin micromovements that occur during subvocalization may be detected in an absence of perceptible vocalization. Movement of facial skin or muscles in an absence of vocalization but which nevertheless conveys speech-related information is referred to herein as silent speech. Detecting silent speech may have various usages, including but not limited to enabling silent communicating with other users, initiating a command, or enabling interaction with a virtual personal assistance. As is discussed herein in greater detail, subvocalization deciphering module 708 in FIG. 7 is a non-limiting example of a software module used for deciphering some subvocalization facial skin micromovements.

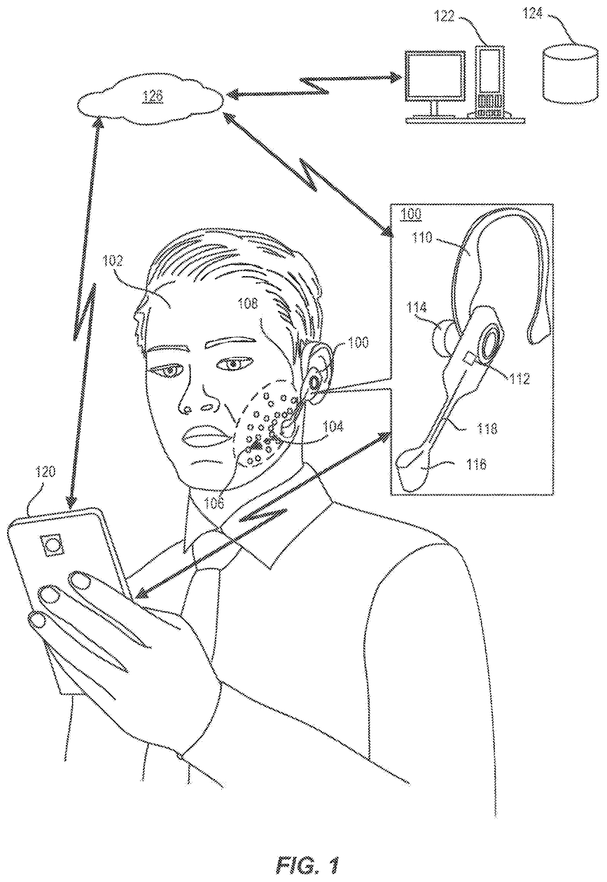

In some embodiments, the detection of the facial skin micromovements occurs using a speech detection system. While the shorthand “speech detection system” is employed, it is to be understood that the system may alternatively or additionally be configured to detect non-speech commands, expressions, or emotions. The system may also be used for user authentication. The speech detection system may include any device of a group of devices operatively coupled together. As used herein, the term “system” includes any device or a group of devices operatively connected together and configured to perform a function. In some embodiments, the system may include a computer (e.g., a desktop computer, a laptop computer, a server, a smart phone, a portable digital assistant (PDA), or a similar device) or plurality of computers or servers operatively connected together (e.g., using wires or wirelessly) to share information and/or data. The computer(s) may include special purpose computers (e.g., hardwired and coded to perform desired functions) or may include general purpose computers (e.g., using software to perform any desired function). In some embodiments, the system may include a cloud server. As described elsewhere in this disclosure, a cloud server may be a computer platform that provides services via a network, such as the Internet. In one embodiment, the speech detection system may include a wearable housing, a coherent light source or a non-coherent light source, a light detector, and a processor. However, the specific list of components mentioned above is not intended to limit systems covered by the present disclosure. As will be appreciated by a person skilled in the art having the benefit of this disclosure, numerous variations and/or modifications may be made to the example speech detection system. For example, not all components may be essential for the detection of facial skin micromovements in all cases. Moreover, the components may be rearranged into a variety of configurations while providing the functionality of various disclosed embodiments. In some cases, a speech detection system according to some embodiments of the disclosure does not have to be wearable, but could be aimed at a skin from a location not connected to a human body. A wearable or a non-wearable system may project coherent light towards a facial region of a user, analyze reflected light, and determine facial skin micromovements. Alternatively, in other cases, a speech detection system according to some embodiments of the disclosure does not have to include a coherent light source. Specifically, the light detector may be an ultra-high resolution image sensor (e.g., more than 120 megapixel) or any other sensor capable of facial micromovement detection, and the detection of the facial skin micromovements may be accomplished using one or more image processing algorithms. As is discussed herein in greater detail, speech detection systems 100 in FIGS. 1-3 are non-limiting examples of a speech detection system, consistent with the present disclosure. As illustrated in these examples, the system includes a wearable housing 110, a light source 410, a light detector 412, and a processing device 400.

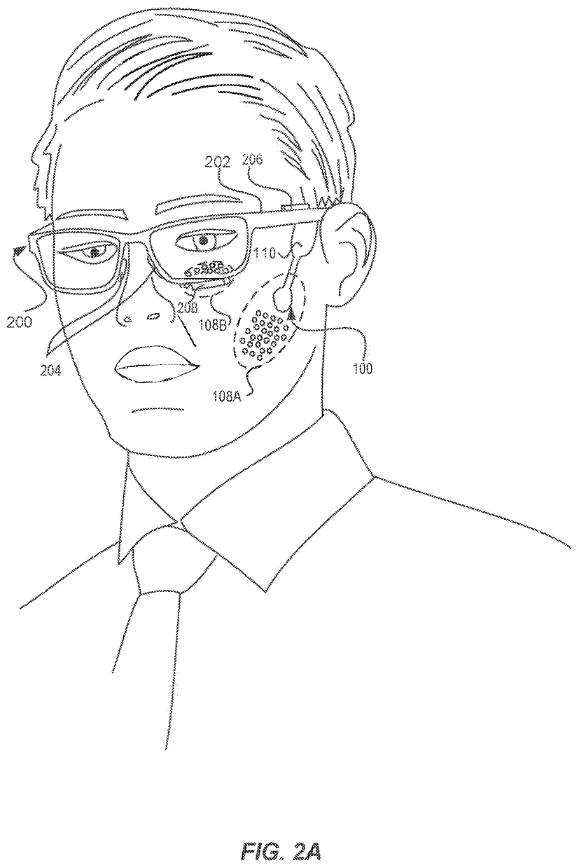

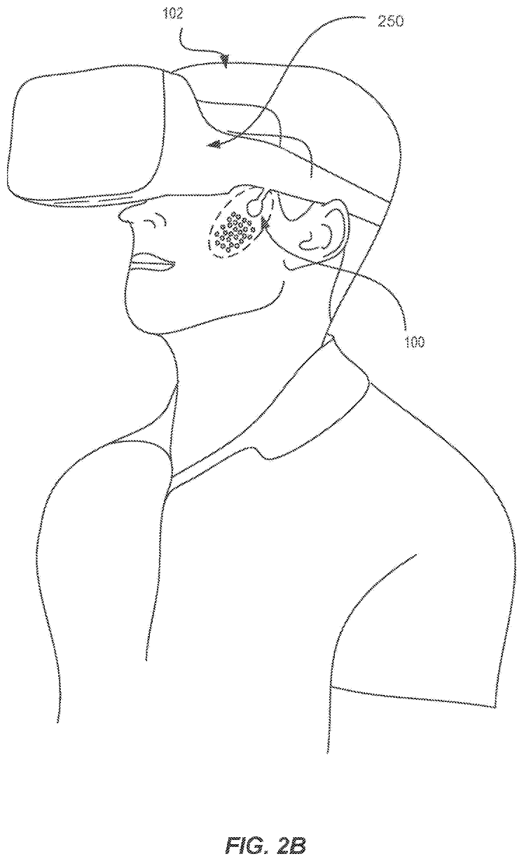

Some disclosed embodiments involve a wearable housing configured to be worn on a head of an individual. The term “wearable housing” broadly includes any structure or enclosure designed for connection to a human head, such as in a manner configured to be worn by a user. Such a wearable housing may be configured to contain or support one or more electronic components or sensors. In one example, the wearable housing is configured for association with a pair of glasses. In another example, the wearable housing is associated with an earbud. The wearable housing may have a cross-section that is button-shaped, P-shaped, square, rectangular, rounded rectangular, or any other regular or irregular shape capable of being worn by a user. Such a structure may permit the wearable housing to be worn on, in, or around a body part associated with a head of the user (e.g., on the ear, in the ear, around the neck). The wearable housing may be made of plastic, metal, composite, a combination of two or more of plastic, metal and composite, or other suitable material. Consistent with disclosure embodiments, the housing may be worn on an ear. There are several ways in which the housing can be attached to the ear: In-the-ear (ITE): the housing may be inserted directly into the ear canal and held in place by the shape of the ear. Examples include earbuds and earplugs. In some cases, the housing may be custom-made to fit the specific shape of an individual's ear and seated in the ear bowl. Behind-the-ear (BTE): the housing may be seated behind the ear and with a small tube that runs to the ear canal. Examples include hearing aids and Bluetooth headsets. Over-the-ear (OTE): the housing may be seated on top of the ear and held in place by a headband or other support. Examples include structures like headphones and earmuffs. Over-the-head (OTH): the housing may be held in place by a headband that goes over the top of the head. In other embodiments, the wearable housing may be attached to a secondary device such as a glasses (sun or corrective vision glasses), a hat, a helmet, a visor, or any other type of head wearable devices. In some cases, the wearable housing may be attached to a secondary device using at least one adapter. Specifically, the at least one adaptor may be configured to enable the individual to wear the speech detection system in two or more different ways. For example, a single adapter may enable the wearable housing to be attached to glasses and to an earbud. As is discussed herein in greater detail, wearable housings 110 in FIG. 1 and FIG. 2A are non-limiting examples of a wearable housing, consistent with the present disclosure.

Some embodiments involve a coherent light source configured to project light towards a facial region of the user. Other embodiments involve a non-coherent light source configured to project light towards a facial region of the user. As used herein, the term “light source” broadly refers to any device configured to emit light. The term “coherent light” includes light that is highly ordered and exhibits a high degree of spatial and temporal coherence. This may occur, for example, when the light waves are in phase with each other and have a uniform frequency and wavelength, resulting in a beam of light that is highly directional and has restricted outward spread out as it travels. Alternatively, coherent light may include a scenario when light waves have constant phase difference. In some examples, coherent light may be produced by a coherent light source, such as lasers and other types of light sources that have a narrow spectral range and a high degree of monochromaticity (i.e., the light consists of a single wavelength). In contrast, incoherent light may be produced by a non-coherent light source such as incandescent bulbs and natural sunlight, which have a broad spectral range and a low degree of monochromaticity.

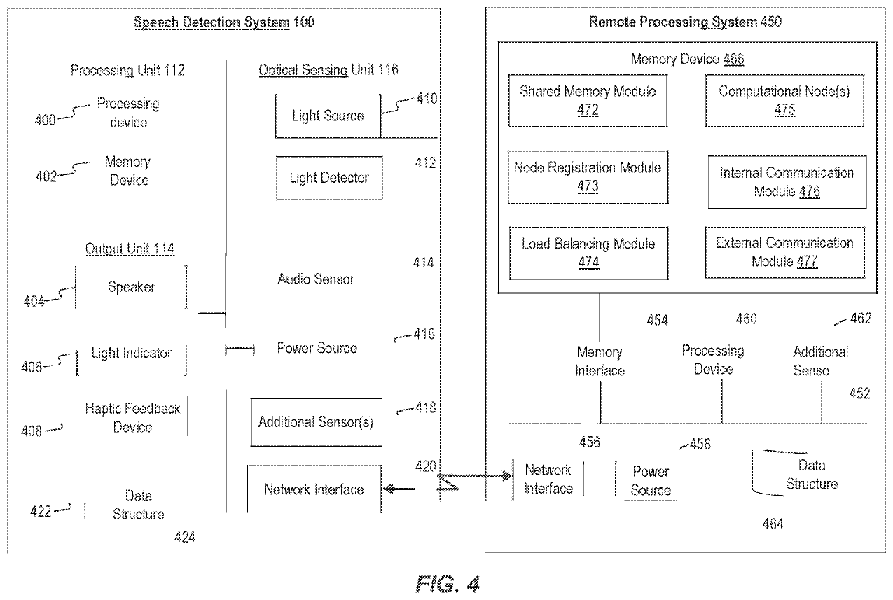

By way of example, coherent light may include many waves of the same frequency, having different phases and amplitudes, not necessarily in the same time and locations. To control the interference, light phase information may be required to be recognized in advance. In one embodiment, the coherent light source may be a laser such as a solid-state laser, laser diode, a high-power laser, Quantum-Cascade Laser (QCLs), or an alternative light source such as a light emitting diode (LED)-based light source. In addition, the coherent light source may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the coherent light source may include a laser diode configured to emit light at a wavelength between about 800 nm and about 1020 nm, between about 850 nm and about 950 nm, or between about 1300 nm and about 1700 nm. Unless indicated otherwise, the terms “about” and “substantially the same,” with regard to a numeric value, may include a variance of up to 5% with respect to the stated value. As is discussed herein in greater detail, light source 410 in FIG. 4 and in FIGS. 5A and 5B are non-limiting examples of a light source, consistent with the present disclosure. In the context of this disclosure, it should be recognized that the use of a coherent light source is intended as a non-limiting example implementation in the context of speech detection systems, methods, and computer readable media. Many of the embodiments described herein may be practiced with coherent light or non-coherent light, and the reference to either by way of example, is not intended to be limiting. For example, even when not explicitly stated, the described and claimed speech detection systems, methods, and computer program products may be configured to measure non-coherent light reflections for detecting facial skin micromovements.

Some embodiments involve at least one detector configured to receive light reflections from a facial region of the user. The term “light detector,” or simply “detector,” broadly refers to any device, element, or system capable of measuring one or more properties (e.g., power, frequency, phase, pulse timing, pulse duration, or other characteristics) of electromagnetic waves and to generate an output relating to the measured property or properties. Examples of detectors consistent with this disclosure may include: a light sensitive sensor, an imaging sensor, a phase detector, a MEMS sensor, a wavemeter, a spectrometer, a spectrophotometer, a homodyne detector, or a heterodyne detector. In some embodiments, the at least one detector may be configured to detect coherent light reflections. Additionally or alternatively, the at least one detector may be configured to detect non-coherent light reflections. The at least one detector may include a plurality of detectors constructed from a plurality of detecting elements. The at least one detector may include a light detector of different types. The at least one detector may include multiple detectors of the same type which may differ in other characteristics (e.g., sensitivity, size). Combinations of several types of detectors may be used for different reasons. Consistent with some embodiments, the at least one detector may measure any form of reflection and of scattering of light, including secondary speckle patterns, different types of specular reflections, diffuse reflections, speckle interferometry, and any other form of light scattering. In some embodiments, the at least one detector is configured to output associated reflection signals from the detected coherent light reflections. In the context of this disclosure, the term “reflection signals” broadly refers to any form of data retrieved from the at least one light detector in response to the light reflections from the facial region. The reflection signals may be any electronic representation of a property determined from the light reflections, or raw measurement signals detected by the at least one light detector. As is discussed herein in greater detail, light detector 412 in FIG. 4 and in FIGS. 5A and 5B are non-limiting examples of a light detector, consistent with the present disclosure.

Some embodiments involve at least one processor configured to use the reflection signals from the detector and determine the facial skin micromovements. The term “at least one processor” may involve any physical device or group of devices having electric circuitry that performs a logic operation on an input or inputs. For example, the at least one processor may include one or more integrated circuits (IC), including an application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively and may be co-located or located remotely from each other. The processors may be coupled electrically, magnetically, optically, acoustically, mechanically, or by other means that permit them to interact. As is discussed herein in greater detail, processing unit 112 in FIG. 1 and processing device 400 in FIG. 4 are non-limiting examples of at least one processor, consistent with the present disclosure

In some embodiments, the at least one processor may determine the facial skin micromovements by applying a light reflection analysis. The term “light reflection analysis” involves the evaluation of properties of a surface by analyzing patterns of light scattered off the surface. When light strikes a surface (e.g., the facial skin), some of it is absorbed, some are transmitted, and some are reflected. The amount and type of light that is reflected depends on the properties of the surface and the angle at which the light strikes it. In one example, when a non-coherent light source is used, the light reflection analysis may include scattering analysis which involves measuring the scattering of light from the surface (e.g., the facial skin). In another example, when a coherent light source is used, the light reflection analysis may include a speckle analysis or any pattern-based analysis. By way of example, coherent light shining onto a rough, contoured, or textured surface may be reflected or scattered in many different directions, resulting in a pattern of bright and dark areas called “speckles.” Such analysis may be performed using a computer (e.g., including a processor) to identify a speckle pattern and derive information about a surface (e.g., facial skin) represented in reflection signals received from at least one light detector. A speckle pattern may occur as the result of the interference of coherent light waves added together to give a resultant wave whose intensity varies. The detected speckle pattern or any other detected pattern may then be processed to generate reflection image data. As is discussed herein in greater detail, light reflections processing module 706 depicted in FIG. 7 is a non-limiting example of a software module used for determining facial skin micromovements by applying a light reflection analysis.

Consistent with the present disclosure, the reflection image data may be processed by any image processing algorithms, including classic and/or artificial neural network (ANN) based algorithms such as Convolutional Neural Network (CNN), Recurrent Neural Networks (RNN). In some examples, the reflection image data may be preprocessed by transforming the image data using a transformation function to obtain a transformed speckle image. For example, the transformed reflection image data may include one or more convolutions of the speckle image. The transformation function may include one or more image filters, such as low-pass filters, high-pass filters, band-pass filters, all-pass filters, and so forth. In some examples, the transformation function may comprise a nonlinear function. In some examples, the reflection image data may be preprocessed by smoothing at least parts of the reflection image data, for example using Gaussian convolution, using a median filter, and so forth. In some examples, the reflection image data may be preprocessed to obtain a different representation of the reflection image data. For example, reflection image data may comprise: a representation of at least part of the reflection image data in a frequency domain; a Discrete Fourier Transform of at least part of the reflection image data; a Discrete Wavelet Transform of at least part of the reflection image data; time/frequency representation of at least part of the reflection image data; a representation of at least part of the reflection image data in a lower dimension; a lossy representation of at least part of the reflection image data; a lossless representation of at least part of the reflection image data; a time-ordered series of any of the above; any combination of the above. In some examples, the reflection image data may be preprocessed to extract edges, and the preprocessed reflection image data may comprise information based on and/or related to the extracted edges. In some examples, the reflection image data may be preprocessed to extract features from the reflection image data. Some examples of such features may comprise information related to edges, corners, blobs, ridges, Scale Invariant Feature Transform (SIFT) features, temporal features, and more.

In some embodiments, performing light reflection analysis may include evaluating the reflection image data and/or the preprocessed reflection image data using one or more rules, functions, procedures, artificial neural networks, object detection algorithms, visual event detection algorithms, action detection algorithms, motion detection algorithms, background subtraction algorithms, inference models, and so forth. Some non-limiting examples of such inference models may include: an inference model preprogrammed manually; a classification model; a regression model; a result of training algorithms, such as machine learning algorithms and/or deep learning algorithms, on training examples, where the training examples may include examples of data instances, and in some cases, a data instance may be labeled with a corresponding desired label and/or result; and so forth. In some embodiments, performing speckle analysis may comprise analyzing pixels, voxels, point cloud, range data, etc. included in the reflection image data.

Some embodiments may involve analyzing the reflection image data to decipher speech. The process of deciphering the speech from the reflection image data may involve identifying patterns or recognizing signatures in the reflection image data. For example, know data, patterns, or signatures may be associated with certain phenomes, combinations of phonemes, words, combinations of words, or any other speech-related component. By recognizing such information in the reflection image data, speech may be deciphered. Such recognition and/or deciphering may be aided by machine learning. For example, machine learning models or algorithms may be employed to recognize and/or understand speech or commands. Some non-limiting examples of machine learning algorithms that may be used include classification algorithms, data regressions algorithms, image segmentation algorithms, visual detection algorithms (such as object detectors, motion detectors, edge detectors, etc.), visual recognition algorithms (such as object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may include an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

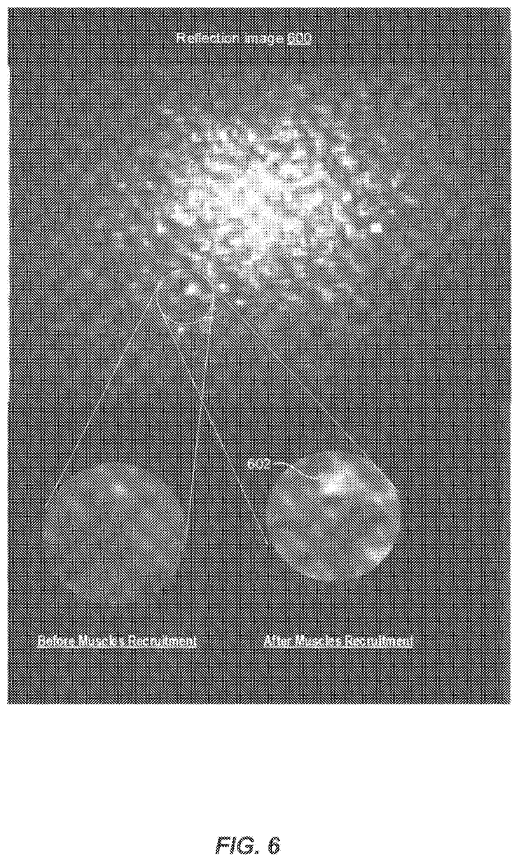

In some examples, deciphering the speech from the reflection image data may involve a trained machine learning algorithm that is used as an inference model that when provided with an input generates an inferred output. For example, a trained machine learning algorithm may include a classification algorithm, the input may include a sample, and the inferred output may include a classification of the sample. In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value for an item depicted in the image (such as an estimated facial skin motion, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth). As is discussed herein in greater detail, reflection image 600 in FIG. 6 is a non-limiting example of a visualization of reflection image data, consistent with the present disclosure.

In some embodiments, artificial neural networks may be configured to analyze inputs and generate corresponding outputs. Some non-limiting examples of such artificial neural networks may include shallow artificial neural networks, deep artificial neural networks, feedback artificial neural networks, feed-forward artificial neural networks, autoencoder artificial neural networks, probabilistic artificial neural networks, time-delay artificial neural networks, convolutional artificial neural networks, recurrent artificial neural networks, long/short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

Disclosed embodiments may include and/or access a data structure or data. A data structure consistent with the present disclosure may include any collection of data values and relationships among them. By way of example, a data structure may contain correlations of facial micromovements with words or phonemes, and the at least one processor may perform a lookup in the data structure of particular words or phenomes associated with detected facial skin micromovements. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database, or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, servers that may be owned or operated by the same or different entities. Thus, the term “data structure” as used herein in the singular is inclusive of plural data structures. As is discussed herein in greater detail, data structure 124 in FIG. 1 and data structures 422 and 464 in FIG. 4 are non-limiting examples of a data structure, consistent with the present disclosure.

Consistent with the present disclosure, at least one processor may generate output associated with the determined facial skin micromovements. The term “generating an output” broadly refers to emitting a command, emitting data, and/or causing any type of electronic device to initiate an action. In some embodiments, the output may be sound (e.g., delivered via a speaker configured to fit in the ear of the user), and the sound may be an audible presentation of words associated with silent or prevocalized speech. In one example, the audible presentation of words may include an answer to a question that the user silently asked a virtual personal assistance. In another example, the audible presentation of words may include synthesized speech (e.g., artificial production of human speech). According to other disclosed embodiments, the output may be directed to a display (e.g., a visual display such as a computer monitor, television, mobile communications device, VR or XR glasses, or any other device that enables visual perception) and the generated output may include graphics, images, or textual presentations of words associated with prevocalized or vocalized speech (e.g., subtitles). The textual presentation of the words may be presented at the same time words are vocalized. In other embodiments, the output may be directed to a communications device associated with the user and the generated output may be any data exchanged with the communications device. The term “communications device” is intended to include all possible types of devices capable of exchanging data using a network configured to convey data. In some examples, the communications device may include a smartphone, a tablet, a smartwatch, a personal digital assistant, a desktop computer, a laptop computer, an Internet of Things (IoT) device, a dedicated terminal, a wearable communications device, and any other device that enables data communications. As is discussed herein in greater detail, output determination module 712 in FIG. 7 is a non-limiting example of a software module used for generating output associated with the determined facial skin micromovements.

Disclosed embodiments may involve exchanging data (e.g., textual data) using a network. The term “communications network,” or simply “network,” may include any type of physical or wireless computer networking arrangement used to exchange data. For example, a network may be the Internet, a private data network, a virtual private network using a public network, a Wi-Fi network, a LAN or WAN network, a combination of one or more of the foregoing, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or an unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near-field communications (NFC), or other suitable communication methods that provide a medium for exchanging data and/or information between separate entities. As is discussed herein in greater detail, communications network 126 shown in FIG. 1, is a non-limiting example of a communications network, consistent with the present disclosure.

As used herein, a non-transitory computer-readable storage medium (or similar constructs such as a non-transitory computer-readable media) refers to any type of physical memory on which information or data readable by at least one processor can be stored. Examples include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within a wearable device or at a remote location. Additionally, one or more computer-readable storage mediums can be utilized in implementing a computer-implemented method. Accordingly, the term computer-readable storage medium should be understood to include tangible items and exclude carrier waves and transient signals.

Reference is now made to FIG. 1, which illustrates a user 102 using a speech detection system consistent with some embodiments of the present disclosure. FIG. 1 is a single exemplary representation, and it is to be understood that some illustrated elements might be omitted, and others may be added within the scope of this disclosure. In the illustrated example implementation, a speech detection system 100 may be mountable on a head of user 102. Specifically, speech detection system 100 (also referred to herein simply as “the system”) may have the form and appearance of an over-the-ear clip-on headset. Alternatively, the system may be head-mountable in one of many other ways within the scope of this disclosure, including an in-ear bud, integration into or connectable to a temple of glasses, a head band, or any other mechanism capable of securing the system or a portion thereof to a human head. Speech detection system 100 may be configured to direct projected light 104 (e.g., coherent light) toward respective locations on the face of user 102, thus creating an array of light spots 106 extending over a facial region 108 of the face. Facial region 108 may have an area of at least 1 cm², at least 2 cm², at least 4 cm², at least 6 cm², or at least 8 cm². In some embodiments, the size of facial region 108 may be determined to enable sensing the motion of different parts of the facial muscles. In the depicted example, only one beam of projected light 104 is illustrated, however, it is contemplated that every spot projected towards facial region 108 may be associated with a corresponding light beam or with one or more light beams. In other embodiments, the light source may project light in a manner other than an array of spots. For example, a region of the face may be uniformly or non-uniformly illuminated.

For embodiments that are head-worn, speech detection system 100 may include a wearable housing 110 configured to be worn on a head of user 102. Wearable housing 110 may include or be associated with a processing unit 112 configured to interpret facial skin micromovements; an output unit 114 configured to fit into the user's ear and to present audible and/or vibrational output; and optical sensing unit 116 configured to project light toward a non-lip part of the face of user 102 and to detect reflections of the projected light. In the illustrated example, optical sensing unit 116 may be connected to output unit 114 by an arm 118 and thus may be held in a location in proximity to and/or facing the user's face. According to some disclosed embodiments, optical sensing unit 116 does not contact the user's skin at facial region 108, but rather optical sensing unit 116 may be held at a certain distance from the skin surface of facial region 108. The distance of optical sensing unit 116 from the skin surface may be at least 5 mm, at least 7.5 mm, at least 10 mm, at least 15 mm, or at least 20 mm.

Optical sensing unit 116 may be configured to receive reflections of light 104 from facial region 108 and to output associated reflection signals. Specifically, the reflection signals may be indicative of light patterns (e.g., secondary speckle patterns) that may arise due to reflection of the coherent light from each of spots 106 within a field of view of speech detection system 100. To cover a sufficiently large facial region 108, the detector of speech detection system 100 may have a wide field of view, for example, the field of view may have an angular width of at least 60°, at least 70°, or at least 90°. Within this field of view, speech detection system 100 may sense and process the signals reflective of light patterns in all of spots 106 or only a certain subset of spots 106. For example, processing unit 112 may select a subset of spots 106 determined to give the largest amount of useful and reliable information with respect to the relevant movements of the skin surface of user 102 and may avoid processing data from other spots 106. Additional details of the structure and operation of optical sensing unit 116 are described below with reference to FIG. 5.

Consistent with the present disclosure, speech detection system 100 may be capable of detecting facial skin micromovements of user 102 and extract meaning from the detected movements, even without vocalization of speech or utterance of any other sounds by user 102. The extracted meaning may be an identification of user 102 wearing speech detection system 100, an identification of a subvocalization by a user, such as a word silently spoken by user 102, an identification of a word vocally spoken by user 102, an identification of a phoneme silently spoken by user 102, or an identification of a phoneme vocally spoken by user 102. Similarly, the extract meaning may include an identification of a heart rate of user 102, an identification of a breathing rate of user 102, and/or other characteristics associated with verbal or non-verbal communication by user 102. In one example, speech detection system 100 may generate output signals that include data associated with an identification information, a UI command, synthesized audio signal, a textual transcription, or any combination thereof. In one example, the synthesized audio signal may be played back to user 102 via a speaker in output unit 114. This playback may be useful in giving user 102 feedback with respect to the speech output.

Consistent with the present disclosure, speech detection system 100 may exchange data (e.g., output signals) with a variety of communications devices associated with users, for example, a mobile communications device 120 or a server 122. The term “communications device” is intended to include all possible types of devices capable of exchanging data using a digital communications network, an analog communication network, or any other communications network configured to convey data. In some examples, the communications device may include a wearable communications device, such as a smartphone, a tablet, a smartwatch, a personal digital assistant, a laptop computer, an IoT device, a dedicated terminal, industrial machinery, a vehicle, a smart house, an appliance, or any other electronic device capable of exchanging information or data with another electronic device. In other examples, the communications device may include a non-wearable communications device, such as a desktop computer, a smart home hub, a router, a server, or any other network-connected equipment. In some cases, a processing device of mobile communications device 120 or server 122 may supplement or replace some functions of processing unit 112 of speech detection system 100. In some embodiments, the output signals generated by speech detection system 100 may be transmitted via a communication link to mobile communications device 120 or to a cloud server. The term “cloud server” refers to a computer platform that provides services via a network, such as the Internet. In the example embodiment illustrated in FIG. 1, a server 122 may use one or more virtual machines that may not correspond to individual pieces of hardware. For example, computational and/or storage capabilities may be implemented by allocating appropriate portions of desirable computation/storage power from a scalable repository, such as a data center or a distributed computing environment. In one example configuration, server 122 may be a cloud server that determines neural activity of user 102 based on facial skin micromovements. In one example, server 122 may implement the methods described herein using customized hard-wired logic, one or more Application Specific Integrated Circuits (ASICs), Field Programmable Gate Arrays (FPGAs), firmware, and/or program logic which, in combination with the computer system, cause server 122 to be a special-purpose machine.

In some embodiments, server 122 may access data structure 124 to determine, for example, correlations between words and a plurality of facial movements. Data structure 124 may utilize a volatile or non-volatile, magnetic, semiconductor, tape, optical, removable, non-removable, other type of storage device or tangible or non-transitory computer-readable medium, or any medium or mechanism for storing information. Data structure 124 may be part of server 122 or separate from server 122, as shown. When data structure 124 is not part of server 122, server 122 may exchange data with data structure 124 via a communication link. Data structure 124 may include one or more memory devices that store data and instructions used to perform one or more features of the disclosed methods. In one embodiment, data structure 124 may include any of a plurality of suitable data structures, ranging from small data structures hosted on a workstation to large data structures distributed among data centers. Data structure 124 may also include any combination of one or more data structures controlled by memory controller devices (e.g., servers) or software. Consistent with the present disclosure, speech detection system 100 may communicate with mobile communications device 120 or server 122 using a communications network 126 as defined above.

Reference is now made to FIG. 2A, which illustrates another example implementation of speech detection system 100, in accordance with the present disclosure. In this example, wearable housing 110 may be integrated with or otherwise attached to a pair of glasses 200 having a frame 202. In this example implementation, glasses 200 may include nasal electrodes 204 and temporal electrodes 206 attached to frame 202 and contacting the user's skin surface. Electrodes 204 and 206 may receive body surface electromyogram (sEMG) signals, which provide additional information regarding the activation of the user's facial muscles. Speech detection system 100 may use the electrical activity sensed by electrodes 204 and 206 together with the output of optical sensing unit 116 in generating, for example, the synthesized audio signals. Additionally or alternatively, speech detection system 100 may include one or more additional optical sensing units 208, similar to optical sensing unit 116, for sensing skin movements in other areas of the user's face, such as eye movement. These additional optical sensing units may be used together with or instead of optical sensing unit 116. In the illustrated example, optical sensing unit 116 may illuminate a first facial region 108A and optical sensing unit 208 may illuminate a second facial region 108B. First facial region 108A and second facial region 108B may be nonoverlapping.

In some disclosed embodiments, the speech detection system may be incorporated with, integrated with, or otherwise attached to an extended reality appliance. As used herein, the term “extended reality appliance” may include any type of device or system that enables a user to perceive and/or interact with an extended reality environment. The term “extended reality environment,” refers to all types of real-and-virtual combined environments and human-machine interactions at least partially generated by computer technology. One non-limiting example of an extended reality environment may be a Virtual Reality (VR) environment. A virtual reality environment may be an immersive simulated non-physical environment which provides the user with the perception of being present in the virtual environment. Another non-limiting example of an extended reality environment may be an Augmented Reality (AR) environment. An augmented reality environment may involve live direct or indirect views of a physical real-world environment enhanced with virtual computer generated perceptual information, such as virtual objects with which the user may interact. Another non-limiting example of an extended reality environment is a Mixed Reality (MR) environment. A mixed reality environment may be a hybrid of physical real-world and virtual environments, in which physical and virtual objects may coexist and interact in real time. Examples of the extended reality appliance may include VR headsets, AR headsets, MR headsets, smart glasses, and wearable projection devices.

Reference is now made to FIG. 2B, illustrating another example implementation of speech detection system 100, in accordance with some embodiments of the present disclosure. In the depicted example, speech detection system 100 may be part of an extended reality appliance 250. Extended reality appliance 250 may include all the sensors discussed above with reference to glasses 200 and more. For example, extended reality appliance 250 may include one or more of a gyroscope, an accelerometer, a magnetometer, an image sensor, a depth sensors, an infrared sensors, a proximity sensor, and/or any other sensor configured to measure one or more properties associated with the individual wearing extended reality appliance 250 and to generate an output relating to the measured property or properties. In some cases, speech detection system 100 may use the input from any one of the sensors of extended reality appliance 250 to determine the vocalized or subvocalized words that user 102 articulated. The term “determining” may refer to establishing or arriving at a conclusive outcome as a result of a reasoned, learned, calculated or logical process. For example, speech detection system 100 may use input from an image sensor of extended reality appliance 250 together with data from optical sensing unit 116 (See FIG. 1) to extract meaning of facial movements. In other cases, extended reality appliance 250 may generate output that includes a visual and/or audible presentation associated with the words detected by the speech detection system 100. For example, user 102 may interact with extended reality appliance 250 using silent commands.

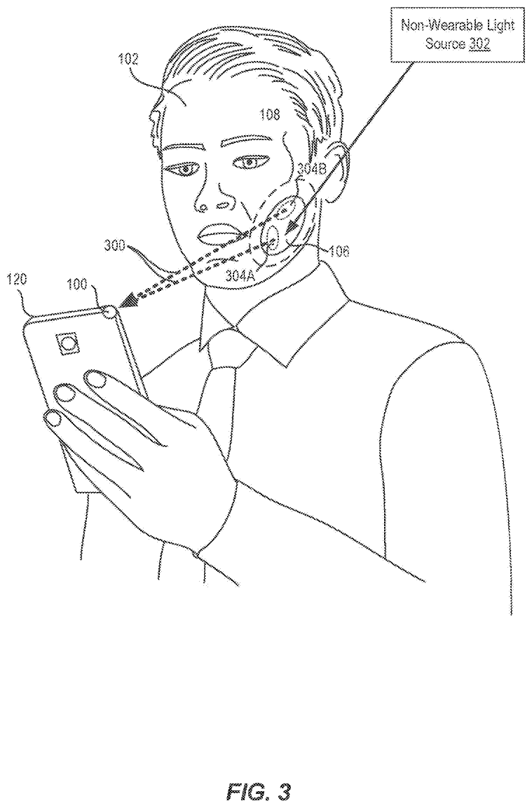

Reference is now made to FIG. 3, which illustrates another example implementation of speech detection system 100, in accordance with the present disclosure. In the implementation illustrated in FIG. 3, speech detection system 100 may be integrated with mobile communications device 120. Specifically, mobile communications device 120 may include a light detector configured to detect reflections 300 of light from facial region 108. In this example, the light projected to facial region 108 originates from a non-wearable light source 302 that may be a coherent light source or non-coherent light source. In some configurations, non-wearable light source 302 may be included in mobile communications device 120. Alternatively, non-wearable light source 302 may be separated from mobile communications device 120.

Consistent with the present disclosure, and as depicted in FIG. 3, the pattern of the light projected to facial region 108 may be a single spot 106 large enough to illuminate different portions of facial region 108. For example, spot 106 may include a first portion 304A associated with a first facial muscle and a second portion 304B associated with a second facial muscle. Thereafter, a processing device of mobile communications device 120 may apply a light reflection analysis on received reflections 300 to determine facial skin micromovements. In particular, the processing device of mobile communications device 120 may determine first facial skin micromovements of first portion 304A and second facial skin micromovements of second portion 304B. The processing device may use both the first facial skin micromovements and the second facial skin micromovements to extract meaning (e.g., determine speech or a command, or to authenticate user 102) and to generate output. The example implementation of speech detection system 100 illustrated in FIG. 3 may be used when the extracted meaning includes a continuous authentication of user 102. Specifically, speech detection system 100 may provide an authentication service that uses biometrics of facial micromovements for continuous authentication during usage of mobile communications device 120.

FIG. 4 is a block diagram of an exemplary configuration of speech detection system 100 and an exemplary configuration of remote processing system 450. It is to be noted that FIG. 4 is a representation of just one embodiment, and it is to be understood that some illustrated elements might be omitted and others added within the scope of this disclosure. In the depicted embodiment, speech detection system 100 comprises processing unit 112 that includes a processing device 400 and a memory device 402; output unit 114 that includes a speaker 404, a light indicator 406, and a haptic feedback device 408; optical sensing unit 116 that includes at least one light source 410 and at least one light detector 412; an audio sensor 414, a power source 416, one or more additional sensors 418, network interface 420, and data structure 422. Speech detection system 100 may directly or indirectly access a bus 424 (or any other communication mechanism) that interconnects the above-mentioned subsystems and components for transferring information and commands within speech detection system 100. Some of the subsystems and components listed above are referred to herein in the singular but in alternative configurations may be plural. For example, in some configurations speech detection system 100 may include multiple light sources 410 or multiple light detectors 412.

Processing device 400, shown in FIG. 4, may constitute any physical device or group of devices having electric circuitry that performs a logic operation on an input or inputs. The instruction executed by at least one processor may, for example, be pre-loaded into a memory integrated with or embedded into processing device 400, or may be stored in a separate memory (e.g., memory device 402 or data structure 422). As described above, the processing device may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively and may be co-located or located remotely from each other. The processors may be coupled electrically, magnetically, optically, acoustically, mechanically, or by other means that permit them to interact. Consistent with the present disclosure, at least some of the functionalities described below regarding processing device 400 may be executed by a processing device of remote processing system 450.

Memory device 402, shown in FIG. 4, may include high-speed random-access memory and/or non-volatile memory, such as one or more magnetic disk storage devices, one or more optical storage devices, and/or flash memory (e.g., NAND, NOR). Consistent with the present disclosure, the components of memory device 402 may be distributed in more than one unit of speech detection system 100 and/or in more than one memory device. In particular, memory device 402 may be used to store a software product and/or data stored on a non-transitory computer-readable medium. As described above, the terms “memory” and “computer-readable storage medium” may refer to multiple structures, such as a plurality of memories or computer-readable storage mediums located within speech detection system 100 or at a remote location (e.g., at remote processing system 450). Additionally, one or more computer-readable storage mediums can be utilized in implementing a computer-implemented method. Examples of software modules stored in memory device 402 are described below with reference to FIG. 7.

Output unit 114, shown in FIG. 4, may cause output from a variety of output devices, such as speaker 404, light indicator 406, and a haptic feedback device 408. Examples of speaker 404 may include or may be incorporated with a loudspeaker, earbuds, audio headphones, a hearing aid type device, a bone conduction headphone, and any other device capable of converting an electrical audio signal into a corresponding sound. In some embodiments, speaker 404 may be configured to let only user 102 to listen to the generated audio signals. Alternatively, speaker 404 may be configured to emit sound into the open air for anyone nearby to hear. Light indicator 406 may include one or more light sources, for example, a LED array associated with different colors. Light indicator 406 may be used to indicate the battery status of speech detection system 100 or to indicate its operational mode. Haptic feedback device 408 may include a vibrating motor, linear actuator, vibrational transducer, or any other force feedback device that provide tactile or haptic cues or can convert an electrical signal into corresponding vibrations or force applications.

Optical sensing unit 116, shown in FIG. 4, may include light source 410 and light detector 412. Light source 410 may project coherent light or non-coherent light to facial region 108. As discussed above, light source 410 may be a laser such as a solid-state laser, laser diode, a high-power laser, or an alternative light source such as a light emitting diode (LED)-based light source. In addition, the light source 410, may emit light in differing formats, such as light pulses, continuous wave (CW), quasi-CW, and so on. In one embodiment, light source 410 may be an infrared laser diode configured to emit an input beam of coherent radiation. Light source 410 may be associated with a beam-splitting element, such as a Dammann grating or another suitable type of diffractive optical element (DOE), for splitting an input beam into multiple output beams, which form respective spots 106 at a matrix of locations extending over facial region 108. In another embodiment (not shown in the figures) light source 410 may include multiple laser diodes or other emitters, which generate respective groups of the output beams, covering different respective sub-areas within facial region 108. In one embodiment, processing unit 112 may select and actuate only a subset of the emitters, without actuating all the emitters. For example, to reduce the power consumption of speech detection system 100, processing unit 112 may actuate only one emitter or a subset consisting of two or more emitters that illuminates a specific area on the user's face that has been found to give the most useful information for generating the desired speech output.

Light detector 412, shown in FIG. 4, may be used to detect reflections from facial region 108 indicative of facial skin movements. As discussed above, a light detector may be capable of measuring properties of coherent or non-coherent light, such as power, frequency, phase, pulse timing, pulse duration, and other properties. In some embodiments, light detector 412 may include an array of detecting elements, for example, a set of a charge-coupled device (CCD) sensors and/or a set of complementary metal-oxide semiconductor (CMOS) sensors, with objective optics for imaging facial region 108 onto the array. Due to the small dimensions of optical sensing unit 116 and its proximity to the skin surface, light detector 412 may have a sufficiently wide field of view to detect many of spots 106 at a high angle of at least 60°, at least 70°, or at least 90°. Light detector 412 may be configured to generate an output relating to the measured properties of the detected light. Consistent with the present disclosure, the output of light detector 412 may include any form of data determined in response to the received light reflections from facial region 108. In some embodiments, the output may include reflection signals that include electronic representation of one or more properties determined from the coherent or non-coherent light reflections. In other embodiments, the output may include raw measurements detected by at least one light detector 412.

In some embodiments, light detector 412 may measure one of more optical attributes associated with skin changes. The term “skin changes” refers to any detectable movements, alterations, or modifications that occurred to the skin. Such skin changes may include changes in the epidermis (i.e., the outermost layer of the skin), changes in the dermis (i.e., the middle layer of the skin), changes in the hypodermis (i.e., the deepest layer of the skin), and changes in deeper muscle tissues. The optical attributes may be measured without contacting the skin of user 102. Examples of one of more optical attributes of the reflected light that may be measured by light detector 412 may include intensity, frequency, reflection, angle, sharpness, bidirectional reflectance distribution function, color, brightness, glossiness, transparency, opacity, surface texture, surface relief, surface movement, and other optical attributes derivable from analysis of light reflections. The output of light detector 412 may be used to determine information associated with skin changes. In some embodiments, the information associated with those skin changes may be derived from changes in a distance from the skin to the detector as the skin moves, and in other embodiments the changes may not be derived from variations in the distance of the skin from light detector 412. For example, the determined speed or angular speed of the changes of the facial skin may be determined by detecting the changes of non-distance measurements (e.g., image sharpness) overtime. Thus, in one nonlimiting example, optical attributes may be detected from random intensity variations observed when coherent light interacts with a rough or scattering surface, such as human skin. In another non-limiting example, optical attributes may be detected based on the interference of light waves, such as when interference patterns are used to measure the phase difference or amplitude changes between two or more optical paths.

In some embodiments, optical sensing unit 116 may not require reference to parameters of the light source, such as the light source's wavelength, intensity, or coherence, and may not require a reference beam (typically used with a beam-splitter) to measure the one or more optical attributes of the reflected light. For example, optical sensing unit 116 may use a single beam to illuminate the skin and then process the light reflections returned to light detector 412. While some speech detection systems may include a single pixel sensor (e.g., a photo diode), in other embodiments, light detector 412 may include one or more multi-pixel sensors (e.g., each pixel sensor includes more than 4 megapixels, more than 10 megapixels, or more than 10 megapixels) that enables producing an image providing spatial information beyond a single point. For example, a reflection image depicted in FIG. 6 may be produced from the output of light detector 412. As described throughout the disclosure, output of light detector 412 may be analyzed using image processing methods to determine patterns of light scattered off a surface. For example, features of secondary speckles may be determined.

In some non-limiting examples, optical sensing unit 116 may use a diffractive element to split the outbound beam to multiple beams and may not rely on superposition of coherent light waves to cause interference. In some non-limiting examples, optical sensing unit 116 may be arranged such that light detector 412 may be positioned along a different optical axis from light source 410. In other non-limiting examples, aligning the light source and the sensor along the same optical axis is needed may be used for maintaining coherence, achieving path length matching, ensuring spatial overlap, and preserving the sensitivity and accuracy of the interference patterns. However, since some implementations of light detector 412 detect a reflection image and not a distance to a point, optical sensing unit 116 may include a first optical axis for outbound light and a second optical axis, not aligned with the first optical axis, for inbound light. In some embodiments, light detector 412 is configured to measure both sub-microbic speed and depth changes in the ranges of 5-500 microns. In alternative embodiments, light detector 412 is configured to measure changes that are less than a micron. All the examples provided in this paragraph are alternatives and may be implemented in the many alternative embodiments provided herein, depending on the specifics of implementation.

Audio sensor 414, shown in FIG. 4, may include one or more audio sensors configured to capture audio by converting sounds to digital information. Some examples of audio sensors may include microphones, unidirectional microphones, bidirectional microphones, cardioid microphones, omnidirectional microphones, onboard microphones, wired microphones, wireless microphones, or any combination of the above. Audio sensor 414 may be configured to capture sounds uttered by user 102, thereby enabling user 102 to use speech detection system 100 as a conventional headphone when desired. Additionally or alternatively, audio sensor 414 may be used in conjunction with the silent speech sensing capabilities of speech detection system 100. In one embodiment, the audio signals output by audio sensor 414 can be used in changing the operational state of speech detection system 100. For example, processing unit 112 may generate the speech output only when audio sensor 414 does not detect vocalization of words by user 102. In another embodiment, audio sensor 414 may be used in a calibration procedure, in which optical sensing unit 116 detects micromovements of the skin while user 102 utters certain phonemes or words. Processing unit 112 may compare the reflection signals output by light detector 412 to the sounds sensed by audio sensor 414 to calibrate optical sensing unit 116. This calibration may include prompting user 102 to shift the position of optical sensing unit 116 to align the optical components in the desired position relative to facial region 108. In yet another embodiment, audio sensor 414 enables on-the-fly training of a neural network of speech detection system 100. For example, speech detection system 100 may be configured to correlate facial skin micromovements with words using audio signals concurrently captured with the micromovements. After recognizing recorded words, speech detection system 100 can perform a look-back to identify facial micromovement that preceded articulation of those words, thereby training speech detection system 100. In a similar way, speech detection systems can be used to train on expressions, commands, user recognition, and emotions.

Power source 416, shown in FIG. 4, may provide electrical energy to power speech detection system 100. A power source may include any device or system that can store, dispense, or convey electric power, including, but not limited to, one or more batteries (e.g., a lead-acid battery, a lithium-ion battery, a nickel-metal hydride battery, a nickel-cadmium battery), one or more capacitors, one or more connections to external power sources, one or more power convertors, or any combination of the foregoing. With reference to the example illustrated in FIG. 4, power source 416 may be mobile, which means that speech detection system 100 can be wearable. The mobility of the power source enables user 102 to use speech detection system 100 in a variety of situations. In other embodiments, power source 416 may be associated with a connection to an external power source (such as an electrical power grid) that may be used to charge power source 416.

Additional sensors 418, shown in FIG. 4, may include a variety of sensors, for example, image sensors, motion sensors, environmental sensors, Electromyography (EMG) sensors, resistive sensors, ultrasonic sensors, proximity sensors, biometric sensors, or other sensing devices configured to facilitate related functionalities. For example, speech detection system 100 may include one or more image sensors configured to capture visual information from the environment of user 102 by converting light (not emitted from light source 410) to image data. Consistent with the present disclosure, an image sensor may be included in any device or system capable of detecting and converting optical signals in the near-infrared, infrared, visible, and/or ultraviolet spectrum into electrical signals. Examples of image sensors may include digital cameras, semiconductor charge-coupled devices (CCDs), active pixel sensors in complementary metal-oxide semiconductor (CMOS), or N-type metal-oxide-semiconductor (NMOS, Live MOS). The electrical signals may be used to generate image data. Consistent with the present disclosure, the image data may include pixel data streams, digital images, digital video streams, data derived from captured images, and data that may be used to construct one or more 3D images, a sequence of 3D images, 3D videos, or a virtual 3D representation. The image data acquired by the one or more image sensors may be transmitted by wired or wireless transmission to processing unit 112 or to remote processing system 450.

Speech detection system 100 may also include one or more motion sensors configured to measure motion of user 102. Specifically, a motion sensor may perform at least one of the following: detect motion of user 102, measure the velocity of user 102, measure the acceleration of user 102, or measure any other action that involves movement. In some embodiments, the motion sensor may include one or more accelerometers configured to detect changes in acceleration (e.g., proper acceleration) and/or to measure acceleration of speech detection system 100. In some embodiments, the motion sensor may include one or more gyroscopes configured to detect changes in the orientation of speech detection system 100 and/or to measure information related to the orientation of speech detection system 100. In some embodiments, the motion sensors may include one or more using image sensors, LIDAR sensors, radar sensors, or proximity sensors. For example, by analyzing captured images, processing device 400 may determine the motion of speech detection system 100, for example, using ego-motion algorithms. In addition, the processing device may determine the motion of objects in the environment of speech detection system 100, for example, through object tracking.

Speech detection system 100 may also include one or more environmental sensors of different types configured to capture data reflective of the environment of user 102. In some embodiments, the environmental sensor may include one or more chemical sensors configured to perform at least one of the following: measure chemical properties in the environment of user 102, measure changes in the chemical properties in the environment of user 102, detect the present of chemicals in the environment of user 102, and/or measure the concentration of chemicals in the environment of user 102. Examples of measurable chemical properties include pH level, toxicity, and temperature. Examples of chemicals or phenomena that may be measured include electrolytes, particular enzymes, particular hormones, particular proteins, smoke, carbon dioxide, carbon monoxide, oxygen, ozone, hydrogen, and hydrogen sulfide. In other embodiments, the environmental sensor may include one or more temperature sensors configured to detect changes in the temperature of the environment of user 102 and/or to measure the temperature of the environment of user 102. In other embodiments, the environmental sensor may include one or more barometers configured to detect changes in the atmospheric pressure in the environment of user 102 and/or to measure the atmospheric pressure in the environment of user 102. In other embodiments, the environmental sensor may include one or more light sensors configured to detect changes in the ambient light in the environment of user 102.

Network interface 420, shown in FIG. 4, may provide two-way data communications to a network, such as communications network 126. In one embodiment, network interface 420 may include an Integrated Services Digital Network (ISDN) card, cellular modem, satellite modem, or a modem to provide a data communication connection over the Internet. As another example, network interface 420 may include a Wireless Local Area Network (WLAN) card. In another embodiment, network interface 420 may include an Ethernet port connected to radio frequency receivers and transmitters and/or optical (e.g., infrared) receivers and transmitters. The specific design and implementation of network interface 420 may depend on the communications network or networks over which speech detection system 100 is intended to operate. For example, in some embodiments, speech detection system 100 may include network interface 420 designed to operate over a GSM network, a GPRS network, an EDGE network, a Wi-Fi or WiMax network, and a Bluetooth network. In any such implementation, network interface 420 may be configured to send and receive electrical, electromagnetic, or optical signals that carry digital data streams or digital signals representing various types of information.

Data structure 422, shown in FIG. 4, may include any hardware, software, firmware, or combination thereof for storing and facilitating the retrieval of information from a database. The term “database” may be understood to include a collection of data that may be distributed or non-distributed. A database may include a database management system that controls the organization, storage and retrieval of data contained within the database. As described above, the data included in the database may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. In disclosed embodiments, data structure 422 may include correlations of facial micromovements with words, commands, emotions, expressions, and/or biological conditions. The at least one processor may perform a lookup in the data structure to thereby interpret the detected facial skin micromovements. In accordance with one embodiment, at least some of the data stored in data structure 422 may alternatively or additionally be stored in remote processing system 450.

Consistent with the present disclosure, speech detection system 100 may be configured to communicate with a remote processing system 450 (e.g., mobile communications device 120 or server 122). Remote processing system 450 may directly or indirectly accesses a bus 452 (or other communication mechanism) interconnecting subsystems and components for transferring information within remote processing system 450. For example, bus 452 may interconnect a memory interface 454, a network interface 456, a power source 458, a processing device 460, one or more additional sensors 462, a data structure 464, and memory device 466.

Memory interface 454, shown in FIG. 4, may be used to access a software product and/or data stored on a non-transitory computer-readable medium or on other memory devices, such as memory devices 402, 466, data structure 422, or data structure 464. Memory device 466 may contain software modules to execute processes consistent with the present disclosure. In some embodiments, memory device 466 may include a shared memory module 472, a node registration module 473, a load balancing module 474, one or more computational nodes 475, an internal communication module 476, an external communication module 477, and a database access module (not shown). Modules 472-477 may contain software instructions for execution by at least one processor (e.g., processing device 460) associated with remote processing system 450. Shared memory module 472, node registration module 473, load balancing module 474, computational node 475, and external communication module 477 may cooperate to perform various operations.

Shared memory module 472 may allow information sharing between remote processing system 450 and other devices related to one or more speech detection systems 100. In some embodiments, shared memory module 472 may be configured to enable processing device 460 to access, retrieve, and store data. For example, using shared memory module 472, processing device 460 may perform at least one of: executing software programs stored on memory devices 402, 466, data structure 422, or data structure 464; storing information in memory devices 402, 466, Data structure 422, or data structure 464; or retrieving information from memory devices 402, 466, data structure 422, or data structure 464.

Node registration module 473 may be configured to track the availability of one or more computational nodes 475. In some examples, node registration module 473 may be implemented as: a software program, such as a software program executed by one or more computational nodes 475, a hardware solution, or a combined software and hardware solution. In some implementations, node registration module 473 may communicate with one or more computational nodes 475, for example, using internal communication module 476. In some examples, one or more computational nodes 475 may notify node registration module 473 of their status, for example, by sending messages: at startup, at shutdown, at constant intervals, at selected times, in response to queries received from node registration module 473, or at any other determined times. In some examples, node registration module 473 may query about the status of one or more computational nodes 475, for example, by sending messages: at startup, at constant intervals, at selected times, or at any other determined times.

Load balancing module 474 may be configured to divide the workload among one or more computational nodes 475. In some examples, load balancing module 474 may be implemented as a software program, such as a software program executed by one or more of the computational nodes 475, a hardware solution, or a combined software and hardware solution. In some implementations, load balancing module 474 may interact with node registration module 473 to obtain information regarding the availability of one or more computational nodes 475. In some implementations, load balancing module 474 may communicate with one or more computational nodes 475, for example, using internal communication module 476. In some examples, one or more computational nodes 475 may notify load balancing module 474 of their status, for example, by sending messages: at startup, at shutdown, at constant intervals, at selected times, in response to queries received from load balancing module 474, or at any other determined times. In some examples, load balancing module 474 may query about the status of one or more computational nodes 475, for example, by sending messages: at startup, at constant intervals, at pre-selected times, or at any other determined times.

Internal communication module 476 may be configured to receive and/or to transmit information from one or more components of remote processing system 450. For example, control signals and/or synchronization signals may be sent and/or received through internal communication module 476. In one embodiment, input information for computer programs, output information of computer programs, and/or intermediate information of computer programs may be sent and/or received through internal communication module 476. In another embodiment, information received though internal communication module 476 may be stored in memory device 466 or in data structure 464. For example, information retrieved from data structure 464 may be transmitted using internal communication module 476. In another example, reference signals reflecting facial micromovements of user 102 may be stored in data structure 464 and accessed using internal communication module 476.

External communication module 477 may be configured to receive and/or to transmit information from one or more speech detection systems 100. For example, control signals may be sent and/or received through external communication module 477. In one embodiment, information received though external communication module 477 may be stored in memory device 466, in data structure 464, and/or any memory device in the one or more speech detection systems 100. In another embodiment, information retrieved from data structure 464 may be transmitted using external communication module 477 to speech detection system 100 or to any entity with whom user 102 communicates. For example, when user 102 communicate with a financial institution (e.g., a bank) information retrieved from data structure 464 may be transmitted to enable authentication of user 102. In another embodiment, sensor data may be transmitted and/or received using external communication module 477. Examples of such input data may include data received from speech detection system 100, information captured from the environment of user 102 using one or more sensors such as additional sensors 418 and additional sensors 462.

In some embodiments, aspects of modules 472-477 may be implemented in hardware, in software (including in one or more signal processing and/or application specific integrated circuits), in firmware, or in any combination thereof, executable by one or more processors, alone, or in various combinations with each other. Specifically, modules 472-477 may be configured to interact with each other and/or other modules of speech detection system 100 to perform functions consistent with disclosed embodiments. Memory device 466 may include additional modules and instructions or fewer modules and instructions.

Network interface 456, power source 458, processing device 460, additional sensors 462, and data structure 464, shown in FIG. 4, may share similar functionality with the functionality of corresponding elements in speech detection system 100, as described above. The specific design and implementation of the above-mentioned components may vary based on the implementation of remote processing system 450. In addition, remote processing system 450 may include more or fewer components. For example, when remote processing system 450 is a mobile communications device associated with user 102 (e.g., mobile communications device 120) it may include a speaker, a microphone, and additional sensors.

The components and arrangements of speech detection system 100 and remote processing system 450 as illustrated in FIG. 4 are not intended to limit the disclosed embodiments. As will be appreciated by a person skilled in the art having the benefit of this disclosure, numerous variations and/or modifications may be made to the depicted configuration of speech detection system 100 and remote processing system 450. For example, not all components may be essential for the operation of an input unit in all cases. Any component may be located in any appropriate part of speech detection system 100 or remote processing system 450. Moreover, the components may be rearranged into a variety of configurations while providing the functionality of the disclosed embodiments. For example, some speech detection systems may not include all of the elements as shown in speech detection system 100 and in remote processing system 450. Other speech detection systems may include additional components and still fall within the scope of this disclosure.

FIGS. 5A and 5B include two schematic illustrations of optical sensing unit 116 as it detects facial skin micromovements in accordance with some embodiments of the present disclosure. The two schematic illustrations show a simplified scenario before muscle recruitment and after muscle recruitment. As depicted, optical sensing unit 116 may include an illumination module 500, a detection module 502, and, optionally, audio sensor 414. As discussed above and illustrated in FIG. 5, optical sensing unit 116 may be configured not to contact the user's skin at facial region 108, but rather may be held at a distance D from the skin surface of facial region 108. The distance D of optical sensing unit 116 from the skin surface may be at least 5 mm, at least 7.5 mm, at least 10 mm, at least 15 mm, or at least 20 mm.

In the depicted embodiment, illumination module 500 includes light source 410 (e.g., an infrared laser diode) configured to generate an input light beam 504. Illumination module 500 further includes a beam-splitting element 506, such as a Dammann grating or another suitable type of diffractive optical element (DOE), configured to split input light beam 504 into multiple output beams 508, which form respective spots 106A-106E at a pattern (e.g., a matrix of locations) extending over facial region 108. In an alternative embodiment (not shown in the figure), illumination module 500 may include multiple light sources 410, which generate respective groups of output beams 508, covering different respective sub-areas within facial region 108. In this alternative embodiment, processing unit 112 may select and actuate only a subset of the multiple light sources, without actuating all of them. For example, to reduce the power consumption of speech detection system 100, processing unit 112 may actuate only one light source or a group of two or more light sources that illuminate a part of facial region 108.

Detection module 502 may include light detector 412, which may include an array 510 of optical sensors (e.g., an array of CMOS image sensors) with objective optics 512 for obtaining reflections 300 of coherent light from facial region 108. Because of the small dimensions of optical sensing unit 116 and its proximity to the skin surface, detection module 502 may be configured to have a wide field of view to acquire reflections from many spots 106 at a high angle. As mentioned above, the field of view of light detector 412 may have an angular width of at least 60°, at least 70°, or at least 90°. Due to the roughness of the skin surface, the light patterns at spots 106 can be detected at these high angles, as well.

Speech detection system 100 may analyze light reflections 300 to determine facial skin micromovements resulting from recruitment of muscle fiber 520. Determining the facial skin micromovements may include determining an amount of the skin movement, determining a direction of the skin movement, and/or determining an acceleration of the skin movement. The determined facial skin micromovements may include voluntary and/or involuntary commitment of muscle fiber 520. Muscle fiber 520 may be part of: a zygomaticus muscle, an orbicularis oris muscle, a risorius muscle, genioglossus muscle, or a levator labii superioris alaeque nasi muscle. Processing device 400 may be configured to perform a first speckle analysis on light reflected from a first region of face in proximity to spot 106A to determine that the first region moved by a distance d1, i.e., first facial skin micromovement 522A; and perform a second speckle analysis on light reflected from a second region of face in proximity to spot 106E to determine that the second region moved by a distance d2, i.e., second facial skin micromovement 522B. Thereafter, processing device 400 may use the determined movements of the first region and the second region to ascertain at least one spoken word. Consistent with disclosed embodiments, distances d1 and d2 may be less than 1000 micrometers, less than 100 micrometers, less than 10 micrometers, or less.

FIG. 6 is a schematic illustration of a reflection image 600 associated with light reflections 300 received from an area of facial region 108 associated with a single spot 106 (e.g., spot 106A depicted in FIG. 5). In disclosed embodiments, processing device 400 may receive reflection signals indicative of coherent light reflections from facial region 108. The reflection signals may be represented by reflection image 600. Thereafter, processing device 400 may determine the facial skin micromovements by applying a light reflection analysis. When light source 410 is a coherent light source, the light reflection analysis may include a speckle analysis or any pattern-based analysis. Such analysis may be performed by processing device 400 or processing device 460 to identify a speckle pattern and derive thereof movement of a corresponding area of facial region 108.

In the depicted example, a speckle 602 appears in reflection image 600 after recruitment of muscle fiber 520. The detected speckle or any other detected pattern may then be processed to generate reflection image data. With reference to the example discussed above, assuming reflection image 600 reflects spot 106A, the reflection image data may include data indicating that the first region moved by a distance d1. In some cases, the reflection image data may be processed by any image processing algorithms (e.g., CNN and RNN) to determine skin movements of at least two areas within facial region 108. Thereafter, processing device 400 may use one or more machine learning (ML) algorithms and artificial intelligence (AI) algorithms to decipher the reflection image data and to extract meaning from the facial skin micromovement.

As shown in FIG. 7, memory device 700 may contain software modules to execute processes consistent with the present disclosure. In particular, memory device 700 may include an illumination control module 702, a sensors communication module 704, a light reflections processing module 706, an artificial neural network (ANN) training module 710, a subvocalization deciphering module 708, an output determination module 712, and a database structure access module 714. The disclosed embodiments are not limited to any particular configuration of memory device 700. Further, processing device 400 and/or processing device 460 may execute the instructions stored in any of modules 702-714 included in memory device 700. It is to be understood that references in the following discussions to a processing device may refer to processing device 400 of speech detection system 100 and processing device 460 of remote processing system 450 individually or collectively. Accordingly, steps of any of the following processes associated with modules 702-714 may be performed by one or more processors associated with speech detection system 100.

Consistent with disclosed embodiments, illumination control module 702, sensors communication module 704, light reflections processing module 706, subvocalization deciphering module 708, ANN training module 710, output determination module 712, and database access module 714 may cooperate to perform various operations. For example, illumination control module 702 may determine light characteristics for illuminating facial region 108. Sensors communication module 704 may receive coherent light reflections from facial region 108 and output associated reflection signals. Light reflections processing module 706 may process the reflection signals to determine facial skin micromovements. Subvocalization deciphering module 708 and database access module 714 may cooperate to extract meaning (e.g., determine silently spoken words) from the facial skin micromovements. In some cases, ANN training module 710 may use the determined silently spoken words and the determined facial skin micromovements to train an artificial network. Output determination module 712 may generate a presentation of the determined words.

Illumination control module 702 may regulate the operation of light source 410 to illuminate facial region 108. In some embodiments, illumination control module 702 may determine values for characteristics of projected light 104 such as light intensity, pulse frequency, duty cycle, illumination pattern, light flux, or any other optical characteristic. In a specific embodiment, as long as user 102 is not speaking, speech detection system 100 may operate in a first illumination mode (e.g., low frame rate) to conserve power of its battery. While speech detection system 100 operates at this first illumination mode, it may process the images to detect at least one trigger in the reflection signals (e.g., a movement of the face) indicative of speech. When such trigger is detected, illumination control module 702 may cause the coherent light source to operate in a second illumination mode (e.g., high frame rate) to enable detection of changes in the coherent light patterns (e.g., speckle) that occur due to silent speech. Illumination control module 702 may also be configured to change one or more characteristics of projected light 104 based on various types of triggers. The various types of triggers may be detected by analysis of data from sensors communication module 704.

Sensors communication module 704 may regulate the operation of light detector 412, audio sensor 414, and additional sensors 418 to receive captured measurements from one or more sensors, integrated with, or connected to, speech detection system 100. In one embodiment, sensors communication module 704 may use the signals received from one or more sensors to generate sensor data associated with user 102. In one example, sensors communication module 704 may receive reflection signals from light detector 412 and may generate a first data stream of reflections images from which the facial skin micromovements in the facial region may be determined. In another example, sensors communication module 704 may receive audio signals from audio sensor 414 and may generate a second data stream from which the words vocally spoken by user 102 may be determined. In another example, sensors communication module 704 may receive motion signals from a motion sensor included in additional sensors 418 and generate a third data stream from which an activity that user 102 is engaged with may be determined. Sensors communication module 704 may convey the sensor data to other software modules for processing.

Light reflections processing module 706 may process the sensor data received from sensors communication module 704 in preparation for speech deciphering. In one embodiment, light reflections processing module 706 may receive from sensors communication module 704 reflection signals indicative of coherent light reflections from facial region 108 that originates from light detector 412. The reflection signals may be represented by a reflection image (e.g., reflection image 600) that can be processed by at least one image processing algorithm to extracts the skin motion at a set of pre-selected locations on the face of user 102. The number of locations to inspect may be an input to the image processing algorithm. In some cases, the locations on the skin that are extracted for coherent light processing may be taken from a list of points of interest. The list of points of interest specifies anatomical locations that correspond with the zygomaticus muscle, the orbicularis oris muscle, the risorius muscle, genioglossus muscle, or the levator labii superioris alaeque nasi muscle. In plain language, the list of points of interest may include specific points in the cheek above mouth, in the chin, in mid-jaw, in the cheek below mouth, in the high cheek, and in the back of the cheek. Consistent with the present disclosure, the list of points of interest may be dynamically updated with more points on the face that are extracted during a training phase. The entire set of locations may be ordered in descending order such that any subset of the list (in order) minimizes the word error rate (WER) with respect to the chosen number of locations that are inspected. In another embodiment, light reflections processing module 706 may crop each of the coherent light spots that were extracted from the raw image frames around the coherent light spots, and the algorithm process only the cropped images. Typically, the process of coherent light spot processing involves reducing by two the order of magnitude of a size of full frame image pixels (of ~1.5 MP) that are received from sensors communication module 704, with a very short exposure. Exposure may be dynamically set and adapted to be able to capture only coherent light reflections and not skin segments. The cropped images of the coherent light spots may depict coherent light patterns. In other embodiments, light reflections processing module 706 may apply an image processing algorithm on the reflection image. For example, light reflections processing module 706 may improve the images' contrast, by removing noise using a threshold to determine black pixels and computing a characteristic metric of the coherent light, such as scalar speckle energy measure, e.g., an average intensity. In addition, light reflections processing module 706 may analyze changes in time in the reflections pattern (e.g., in average speckle intensity). Alternatively, other metrics may be used such as the detection of specific coherent light patterns. Thereafter, light reflections processing module 706 may assign a sequence of values of the characteristic metric of the coherent light, which may be calculated frame-by-frame and aggregated to generate reflection image data indicative of facial skin micromovements. Light reflections processing module 706 may convey the reflection image data indicative of facial skin micromovements to other software modules for processing.

Subvocalization deciphering module 708 may use machine learning (ML) algorithms and artificial intelligence (AI) algorithms to decipher the reflection image data indicative of facial skin micromovements received from light reflections processing module 706. Consistent with the present disclosure, deciphering the reflection image data may include extracting meaning from the detected facial skin micromovements. In one embodiment, subvocalization deciphering module 708 may use a trained ANN to correlate words with the facial skin micromovements. Different types of ANNs may be used, such as a classification NN that eventually outputs words, and a sequence-to-sequence NN which outputs a sentence (word sequence). In some embodiments, during normal speech of the user, system 100 may simultaneously sample the voice of user 102 and the facial movements. Automatic speech recognition (ASR) and Natural Language Processing (NLP) algorithms may be applied by subvocalization deciphering module 708 on the actual voice, and the outcome of these algorithms may be used for optimizing the parameters of the algorithms used by subvocalization deciphering module 708. These parameters may include the weights of the various neural networks, as well as the spatial distribution of laser beams for optimal performance. In addition, subvocalization deciphering module 708 may limit the output of the algorithms to a pre-defined word set may significantly increase the accuracy of word detection in cases of ambiguity, i.e., when two different words result in similar micromovements on the facial skin. The used word set can be personalized overtime, adjusting the dictionary to the actual words used by the specific user, with their respective frequency and context. In addition, subvocalization deciphering module 708 may use the context of a conversation between user 102 and a callee. The context may be determined from the input of the words and sentences extraction algorithms to increase the accuracy by eliminating out-of-context options. The context of the conversation may be understood by applying Automatic speech recognition (ASR) and Natural Language Processing (NLP) algorithms on the side of user 102 and on the side of the callee.

ANN training module 710 may be used to train an ANN to perform silent speech deciphering, in accordance with embodiments of the disclosure. To train an ANN such as the one that may be used by subvocalization deciphering module 708 may require several thousands of examples. To achieve this, ANN training module 710 may rely on a large group of people (e.g., a group of reference human subjects). In one example, subvocalization deciphering module 708 may perform fine adjustments to the ANN such that it is customized to user 102. In this manner, within minutes or less of wearing speech detection system 100, subvocalization deciphering module 708 may be ready for deciphering the facial skin micromovements. ANN training module 710 can be used to train two different ANN types: a classification neural network that eventually outputs words, and a sequence-to-sequence neural network which outputs a sentence (word sequence). To do so, ANN training module 710 may upload from a memory training data, such as silent speech data received from light reflections processing module 706 that was gathered from multiple reference human subjects. The silent speech data may be collected from a wide variety of people (people of varying ages, genders, ethnicities, physical disabilities, etc.). It is to be noted that the number of examples required for learning and generalization may be task-dependent. For word/utterance prediction (within a closed group) at least several thousands of examples may be gathered. Thereafter, ANN training module 710 may augment the image processed training data to get more artificial data for the training process. In particular, the augmented data may include image processed coherent light patterns, with some of the image processing steps described herein. The data augmentation process may include the steps of (i) time dropout, where amplitudes at random time points are replaced by zeros; (ii) frequency dropout, where the signal is transformed into the frequency domain, and random frequency chunks are filtered out; (iii) clipping, where the maximum amplitude of the signal at random time points is clamped. This clipping may add a saturation effect to the data; (iv) noise addition, where Gaussian noise is added to the signal, and speed change, where the signal is resampled to achieve a slightly lower or slightly faster signal.

The augmented dataset may go through a feature extraction process. In this process, ANN training module 710 may compute time domain silent speech features. For this purpose, for example, each signal may be split into low and high frequency components, x low and x high, and windowed to create time frames, for example, using a frame length of 27 ms and shift of 10 ms. For each of the frame five time-domain features and the nine frequency domain features, a total of 14 features per signal may be computed. Specifically, the time-domain features may be represented as follows:

$$[ \frac{1}{n} {\sum }_{i} {( {x}_{low} [ i ] )}^{2} , \frac{1}{n} {\sum }_{i} {x}_{low} [ i ] , \frac{1}{n} {\sum }_{i} {( {x}_{high} [ i ] )}^{2} , \frac{1}{n} {\sum }_{i} \vert {x}_{high} [ i ] \vert , ZCR ( {x}_{high} ) ]$$

where ZCR is the zero-crossing rate. In addition, in this example, the magnitude values used are from a 16-point short Fourier transform, i.e., frequency domain features and all features are normalized to zero mean unit variance.

Thereafter, ANN training module 710 may split the data into training, validation, and test sets. The training set may be the data used to train the model. Hyperparameter tuning may be done using the validation set, and final evaluation may be done using the test set. The model architecture may be task dependent. Two different examples describe training two networks for two conceptually different tasks. A first task may include signal transcription, i.e., translating silent speech to text by generating a word, a phoneme, or a letter. This first task may be addressed by using a sequence-to-sequence model. A second task may include predicting a word or an utterance, i.e., categorizing utterances uttered by users into a single category within a closed group. This second task may be addressed by using a classification model. The disclosed sequence-to-sequence model may be composed of an encoder, which may transform the input signal into high level representations (embeddings), and a decoder, which produces linguistic outputs (i.e., characters or words) from the encoded representations. The input entering the encoder may be a sequence of feature vectors. In one example, the input may enter the first layer of the encoder, a temporal convolution layer, which may down-sample the data to achieve a good performance. The model may use an order of a hundred of such convolution layers.

In some embodiments, the outputs from the temporal convolution layer at each time step may be passed to three layers of bidirectional recurrent neural networks (RNN). ANN training module 710 may employ long short-term memory (LTSM) as units in each RNN layer. Each RNN state may be a concatenation of the state of the forward RNN with the state of the backward RNN. The decoder RNN may be initialized with the final state of the encoder RNN (concatenation of the final state of the forward encoder RNN with the first state of the backward encoder RNN). At each time step, the decoder RNN may receive as input the preceding word, encoded one-hot and embedded in a 150-dimensional space with a fully connected layer. The decoder RNN output may be projected through a matrix into the space of words or phonemes (depending on the training data). The sequence-to-sequence model may condition the next step prediction on the previous prediction. During learning, a log probability may be maximized:

$${max}_{θ} {\sum }_{i} log P ( {y}_{i} \vert x , {y}_{< i}^{*} ; θ )$$

where y<i is the ground truth of the previous prediction. The classification neural network may be composed of the encoder as in the sequence-to-sequence network and an additional fully connected classification layer on top of the encoder output. The output may be projected into the space of closed words and the scores may be translated into probabilities for each word in the dictionary. The results of the above entire procedure may include two types of trained ANNs, expressed in computed coefficients. The coefficients may be stored in a data structure associated with speech detection system 100 (e.g., data structure 422 and data structure 464). In day-to-day use, ANN training module 710 may receive up to date coefficients for the trained ANN. The first ANN task may be the signal transcription, i.e., translating silent speech to text by word/phoneme/letter generation. The second ANN task may be word/utterance prediction, i.e., categorizing utterances uttered by users into a single category within a closed group.

Output determination module 712 may regulate the operation of output unit 114 and the operation of network interface 420 to generate output using speaker 404, light indicator 406, haptic feedback device 408, and/or to send data to a remote computing device. In some embodiments, the output generated by output determination module 712 may include various types of output associated with silent speech determined from detected facial skin micromovements. Specifically, output determination module 712 may synthesize vocalization of words determined from the facial skin movements by subvocalization deciphering module 708. The synthesis may emulate a voice of user 102 or emulate a voice of someone other than user 102 (e.g., a voice of a celebrity or preselected template voice). The vocalization of the words may be presented via speaker 404 or transmitted to the remote computing device via network interface 420. Alternatively, output determination module 712 may generate a textual output from the facial skin movements by subvocalization deciphering module 708. The textual output may be transmitted to the remote computing device via network interface 420. According to another embodiment, the output generated by output determination module 712 may relate to the operation of speech detection system 100. In some cases, light indicator 406 may include a light indicator that shows the battery status of speech detection system 100. For example, the light indicator may start to blink when speech detection system 100 has a low battery. Additional examples of the types of output that may be generated by output determination module 712 are described throughout the present disclosure.

Database access module 714 may cooperate with data structures 422 and 464 to retrieve stored data. The retrieved data may include, for example, correlations between a plurality of words and a plurality of facial skin movements, correlations between a specific individual and a plurality of facial skin micromovements associated with the specific individual, and more. As described above, subvocalization deciphering module 708 may use a trained ANN to perform silent speech deciphering. The trained ANN may use data stored in data structures 422 and 464 to extract meaning from detected facial skin micromovements. Data structures 422 and 464 may include separate databases, including, for example, a vector database, raster database, tile database, viewport database, and/or a user input database. The data stored in data structures 422 and 464 may be received from modules 702-712 or other components of speech detection system 100. Moreover, the data stored in data structures 422 and 464 may be provided as input using data entry, data transfer, or data uploading.

Modules 702-714 may be implemented in software, hardware, firmware, a mix of any of those, or the like. Processing devices of speech detection system 100 and remote processing system 450 may be configured to execute the instructions of modules 702-714. In some embodiments, aspects of modules 702-714 may be implemented in hardware, in software (including in one or more signal processing and/or application specific integrated circuits), in firmware, or in any combination thereof, executable by one or more processors, alone, or in various combinations with each other. Specifically, modules 702-714 may be configured to interact with each other and/or other modules associated with speech detection system 100 to perform functions consistent with disclosed embodiments.

In accordance with one implementation, a speech detection system projects a pattern of light on facial skin (e.g., a cheek) of a user. Thereafter, the speech detection system may detect light reflections from various locations of the facial skin. Notably, reflections associated with specific areas may be more relevant for extracting meaning (e.g., determining communication) than other areas. The specific areas may be those that are located closer to particular facial muscles. Identifying the specific locations may pose challenges because each user has unique facial features, and the position of the light source and/or detector relative to the user's face may change during every usage and even during ongoing operations. The following paragraphs describes systems, methods, and computer program products for identifying the locations of those specific areas, using the light reflections from the specific areas to extract meaning, and ignoring light reflections from other areas to conserve processing resources.

Some disclosed embodiments involve interpreting facial skin movements. The term “interpreting facial skin movements” refers to extracting meaning from detected skin movements, as described elsewhere in this disclosure. In one example, interpreting facial skin movements may include determining one or more vocalized or subvocalized words from the facial skin movements or determining a facial expression (e.g., happy, sad, anger, fear, surprise, disgust, contempt, or other emotion) of the individual. In another example, interpreting facial skin movements may include determining an identity of the individual. These facial skin movements may be detectable as described elsewhere in this disclosure.

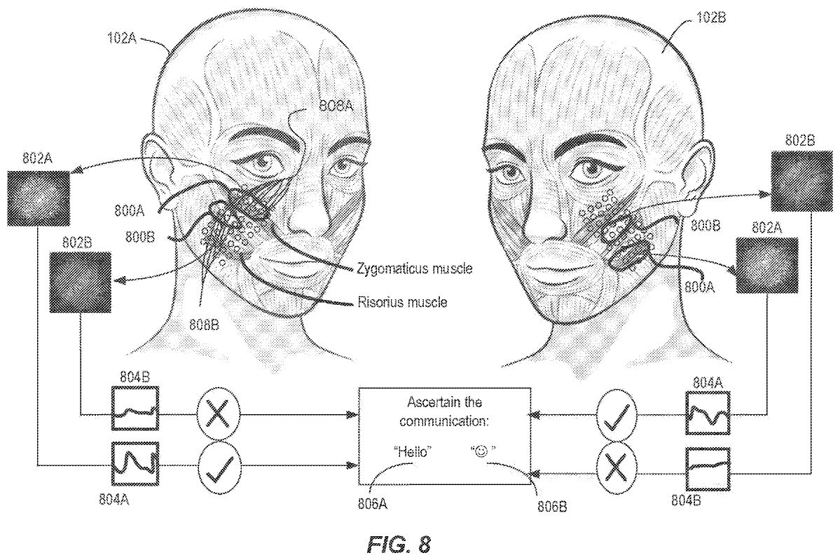

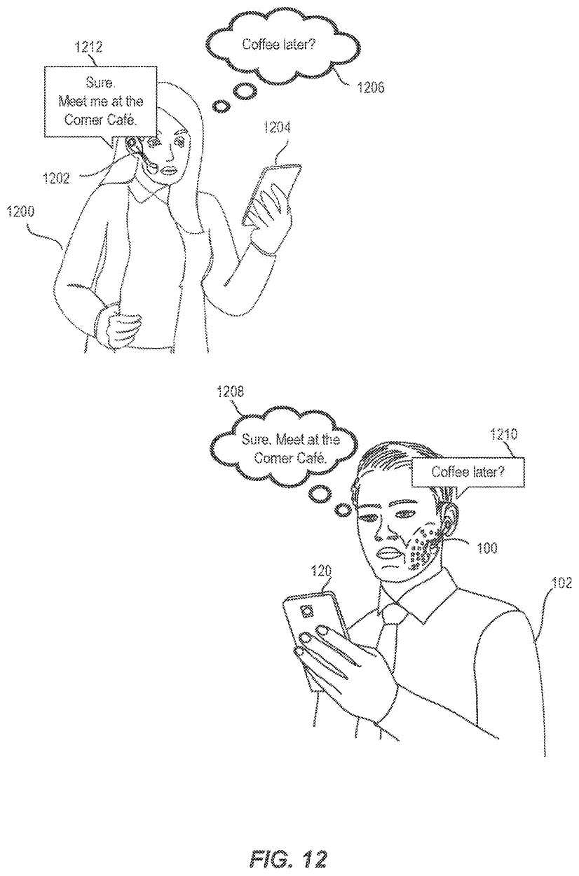

Some disclosed embodiments involve projecting light on a plurality of facial region areas of an individual, wherein the plurality of areas includes at least a first area and a second area. The term “projecting” includes controlling a light source (e.g., a coherent light source) such that it emits light in a given direction (e.g., toward a portion of the face), as discussed elsewhere in this disclosure. The term “individual” includes a person who uses a speech detection system (or another person to whom the light source is projected), as described elsewhere in this disclosure. The term “facial region area” or simply “area” in the context of the face includes a portion of the face of the individual, as described elsewhere in this disclosure. For example, a facial region area may have a size of at least 1 cm², at least 2 cm², at least 4 cm², at least 6 cm², or at least 8 cm². Consistent with some disclosed embodiments, the projected light illuminates a plurality of facial region areas. For example, the plurality of areas includes 4, 8, 16, 32, or any other numbers of areas. In some cases, the projected light may include at least one spot, as described elsewhere in this disclosure. The at least one spot may illuminate more than one facial region area, for example, as illustrated in FIG. 3, a single spot 106 may illuminate different portions of facial region 108. For example, spot 106 may include a first portion 304A associated with a first facial muscle and a second portion 304B associated with a second facial muscle. Alternatively, a single facial region area may be illuminated by multiple light spots. Some of the plurality of areas may be spaced apart from each other while others of the plurality of areas may be overlapping with each other. The term “spaced apart” may refer to being non-overlapping or separated by at least some distance. Thus, spaced apart areas may refer to two or more facial region areas that do not overlap with each other and have even a very small gap in between. For example, stating that a first facial region area is spaced apart from a second facial region area may include distances between the first and second region of at least 5 mm, at least 10 mm, at least 15 mm, or any other desired distance. In some embodiments the distance may be less than 1 mm, or between 1 mm and 5 mm. In some cases, only a portion of a facial region area may be illuminated by the projected light. In other cases, all of the facial region areas may be illuminated by the projected light. By way of example, FIGS. 8 and 12 illustrate illuminating plurality of facial region areas of an individual using a plurality of spots. As illustrated, each of areas 800A and 800B are illustrated by more than one light spot.

Some disclosed embodiments involve illuminating at least a portion of the first area and at least a portion of the second area with a common light spot. As used herein, the term “at least a portion” and/or grammatical equivalents thereof can refer to any fraction of a whole amount. For example, “at least a portion” can refer to at least about 1%, 5%, 10%, 20%, 40%, 65%, 90%, 95%, 99%, 99.9%, or 100% of a whole amount, or any other fraction. The term “common light spot” means that a single (common) light spot may cover some or all of the first area and the second area. The common light spot may illuminate at least a portion of the first area and the second area. In one example, the common light spot may illuminate 30% of the first area and 10% of the second area. In another example, the common light spot may illuminate 100% of the first area and 100% of the second area. Controlling the at least one coherent light source may include illuminating a continuous area on the face that includes the first area and the second area. By way of one example, as illustrated in FIG. 3 single light spot 106 may illuminate two or more facial areas (e.g., 304A and 304B).

Some disclosed embodiments involve illuminating the first area with a first group of spots and illuminating the second area with a second group of sports distinct from the first group of spots. The term “group of spots” refers to more than one light spot. The number of spots in the group of spots may range from two to 64 or more. For example, the group of spots may include 4 spots, 8 spots, 16 spots, 32 spots, 64 spots, or any number of spots greater than two. There may be variations in illumination characteristics between spots or within the group of spots, as discussed elsewhere in this disclosure. Illuminating an area with a group of spots may refer to illuminating some or all of a facial area region by two or more spots. In one example, the group of spots may illuminate at least 15% of the area, at least 40% of the area, or at least 70% of the area. A first area may be illuminated by a first group of spots and a second area may be illuminated by a second group of spots distinct from the first group of spots. In this context, the term “distinct” means that the first group of spots is distinguishable from the second group of spots. For example, the first group of spots may include at least one spot not included in the second group of spots. By way of example, FIGS. 8 and 12 illustrate a first area facial regions 800A illuminated by a first group of spots 808A and a second area 800B illuminated by a second group of sports 808B distinct from the first group of spots.

Some disclosed embodiments involve operating a coherent light source (as described elsewhere in this disclosure) located within a wearable housing (as described elsewhere in this disclosure) in a manner enabling illumination of the plurality of facial region areas. Enabling illumination, as used herein, may refer to a process of controlling a light source to generate at least one light beam and directing the at least one light beam toward the plurality of facial region areas. For example, enabling illumination may also include utilizing a beam-splitting element (as described elsewhere in this disclosure) configured to split an input beam into multiple output beams (as described elsewhere in this disclosure) extending over a portion of a face. In an alternative embodiment, enabling illumination may include utilizing multiple light sources which generate respective groups of output beams, covering different respective sub-areas within a portion of a face. FIGS. 1 and 2 illustrate an example implementation of speech detection system (e.g., speech detection system 100) in which at least one facial region area (e.g., facial region 108) is illuminated by a plurality of light spots (e.g., light spots 106). In some embodiments, the plurality of light spots may be generated by optical sensing unit 116 that includes at least one light source 410 and at least one light detector 412 and located in a wearable housing 110.

Some disclosed embodiments involve operating a coherent light source (as described elsewhere in this disclosure) located remote from a wearable housing (as described elsewhere in this disclosure) in a manner enabling illumination of the plurality of facial region areas (as described elsewhere in this disclosure). The term “located remote” indicates that two objects are separated from each other and with a physical distance between them such that they do not appear physically as a unified component. For example, the coherent light source may be part of device other than the speech detection system and located more than 1 cm from a wearable housing of the speech detection system. As another example, the coherent light source may be located more than 3 cm from a wearable housing of the speech detection system. It should be understood that the distances 1 cm and 3 cm are exemplary and nonlimiting and other distances may be used. FIG. 3 illustrate an example implementation of speech detection system in which a plurality of facial region areas (e.g., first portion 304A of facial region 108 and second portion 304B of facial region 108) are illuminated by a coherent light source located remote from the wearable housing (e.g., a non-wearable light source 302).

In some disclosed embodiments, the first area is closer to at least one of a zygomaticus muscle or a risorius muscle than the second area. The phrase “a first area is closer to a muscle than a second area” means that a distance of the first area to a specific muscle is less than a distance of the second area to a specific muscle. For example, the distances may be measured from an edge of an area to an edge of specific muscle, from a center of an area to a center of a specific muscle, or any combination thereof. In this context, the center of a shape (i.e., the first area, the second area, or a specific muscle) may be a geometric center, which is the point which corresponds to the mean position of all the points in shape; a circumscribed center, which is the center of the smallest circle that completely encloses the 2D shape; an incenter, which is the center of the inscribed circle that is tangent to all sides of the 2D shape, or any other reference point previously defined. As discussed, the first area is closer to at least one of a zygomaticus muscle or a risorius muscle than a second area. In other words, the disclosed embodiments capture two example use cases, the first example use case is that the first area is closer to the zygomaticus muscle than the second area. The second example use case is that the first area is closer to the risorius muscle than the second area. By way of example, FIG. 8 illustrates one implementation of the first and second example use cases. Specifically, the first use case is illustrated with regards to user 102A and the second use case is illustrated with regards to user 102B.

FIG. 8 illustrates two example use cases for interpreting facial skin movements. In both example use cases, a plurality of facial areas 800 of user 102 may be illuminated by at least one light source (e.g., light source 410, not shown). The depicted plurality of areas includes at least a first area 800A and a second area 800B. In the first example use case involving user 102A, first area 800A is closer to the zygomaticus muscle than second area 800B, and in the second example use case involving user 102B, first area 800A is closer to the risorius muscle than second area 800B.

Some disclosed embodiments involve receiving reflections from the plurality of areas. The term “receiving” may include obtaining, retrieving, acquiring, or otherwise gaining access to data or signals. In some cases, receiving may include reading data from memory and/or obtaining data from a computing device via a (e.g., wired and/or wireless) communications channel. In other cases, receiving may include detecting electromagnetic waves (e.g., in the visible or invisible spectrum) and generating an output relating to measured properties of the electromagnetic waves. In a first embodiment, at least one processor may receive data indicative of light reflected from the plurality of areas from at least one detector. In a second embodiment, at least one detector may receive light rays reflected from the plurality of areas. The term “reflections” refers to one or more light rays bouncing off a surface (e.g., the individual's face) or data derived from the one or more light rays bouncing off the surface. For example, the reflections may include light detected by a light detector after it was deflected from an object. The light detected by the light detector may be generated by at least one coherent light source of the disclosed speech detection system and/or may be generated from sources other than the disclosed speech detection system. By way of one example, light detector 412 in FIGS. 5A and 5B is employed to receive reflections 300 that originated from light generated by light source 410.

By way of example with reference to the two uses cases depicted in FIG. 8, a reflection image 802A may represent the reflections received from the first area 800A, and reflection image 802B may represent the reflections received from the second area 800B. As illustrated, in the first example use case, reflection image 802A represents the reflections received from an area closer to the zygomaticus muscle; and in the second example use case, reflection image 802A represents the reflections received from an area closer to the risorius muscle.

Some disclosed embodiments involve detecting first facial skin movements corresponding to reflections from the first area and second facial skin movements corresponding to reflections from the second area. The term “detecting” in this context refers to the process of discovering, identifying, or determining the existence of light reflections (or signals associated therewith). In one example, a change in the position of facial skin may be detected. As discussed elsewhere in this disclosure, the detection process may involve using various techniques or technologies to determine the existence of the pattern or the event. In some cases, the process of detecting facial skin movement may involve determining if there is any movement that occurred and recording information representing the detected movement. For example, at least one processor may detect facial skin movements by applying a light reflection analysis on received reflections. In other cases, detecting facial skin movements may include determining times in which facial skin movements occurred. In other cases, detecting facial skin movements may include determining data representing the facial skin movements (e.g., direction, velocity, acceleration). The term “facial skin movements” broadly refers to any type of movements prompted by recruitment of underlying facial muscles. The facial skin movements include facial skin micromovements—as described elsewhere in this disclosure—and larger-scale skin movements generally visible and detectable to the naked eye without the need for magnification (e.g., a smile, a yawn, a frown). The term “the facial skin movements corresponding to reflections from a specific area” means that the detected facial skin movements took place in a specific area of the face from which reflections were received. For example, detecting first facial skin movements corresponding to reflections from the first area means that the first facial skin movements may be detected by analyzing reflections received from the first area; and detecting second facial skin movements corresponding to reflections from the second area means that the second facial skin movements may be detected by analyzing reflections received from the second area.

In some disclosed embodiments, detecting the first facial skin movements involves performing a first speckle analysis on light reflected from the first area, and detecting the second facial skin movements involves performing a second speckle analysis on light reflected from the second area. The term “performing” refers to the act of carrying out a task, activity, or function. The term “speckle analysis” may be understood as described elsewhere in this disclosure. Consistent with the present disclosure, performing a speckle analysis may include detecting a speckle pattern, or any other patterns in signals received from a light reflected from a facial region area. For example, performing a speckle analysis may include identifying secondary speckle patterns that arise due to reflection of the coherent light from each area. In other embodiments, detecting facial skin movements may involve performing a pattern-based analysis or an image-based analysis additionally or alternatively from performing a speckle analysis.

Consistent with some disclosed embodiments, the first speckle analysis and the second speckle analysis occur concurrently by the at least one processor, the term “occur concurrently” means that two or more events occur during coincident or overlapping time periods, either where one begins and ends during the duration of the other, or where a later one starts before the completion of the other. In some cases the two or more events may be speckle analyses (or any pattern-based analysis). In order for the first speckle analysis and the second speckle analysis to occur concurrently, the at least one processor may include a plurality of processors or a multi-core processor that allows multiple speckle analyses to be executed simultaneously.

By way of example with reference to the two uses cases depicted in FIG. 8, first facial skin movements 804A may correspond to reflections from the first area 800A and second facial skin movements 804B may correspond to reflections from the second area 800B. For example, in the first example use case, first facial skin movements 804A correspond to reflections received from an area closer to the zygomaticus muscle; and in the second example use case, second facial skin movements 804B correspond to reflections received from an area closer to the risorius muscle.

Some disclosed embodiments involve determining, based on differences between the first facial skin movements and the second facial skin movements, that the reflections from the first area closer to the at least one of a zygomaticus muscle or a risorius muscle are a stronger indicator of communication than the reflections from the second area. Determining refers to ascertaining. For example, from the differences between the first and second facial skin movements, the processor may determine which is closer to the associated muscle. The differences between the first facial skin movements and the second facial skin movements may include any distinctions, variations, or dissimilarities between the first facial skin movements and the second facial skin movements. The differences between the first facial skin movements and the second facial skin movements may be determined using at least one of the following techniques: surface alignment, point-to-point comparison, surface registration, topological analysis, or any other technique for determining differences between two data sets. For example, the differences between the first facial skin movements and the second facial skin movements may include differences in the movement intensity, movement trajectory, the movement speed, and/or various changes in topography the facial skin. Based on the differences, the at least one processor may determine that reflections from a first area are a stronger indicator of communication than the reflections from a second area. The term “communication” refers to the process of conveying information through various mediums, such as spoken language, words, body language, gestures, or signals. For example, the communication may include verbal cues (e.g., words, phrases, and language) and non-verbal cues (e.g., body language, facial expressions, gestures, and eye contact). The term “indicator of communication” refers to a measure or sign reflective of an information conveyed by the individual. For example, the statement that reflections from the first area are a stronger indicator of communication than the reflections from a second area means that it may be easier to determine that the individual intends to convey information and what communication the individual intends to convey from the first facial skin movements than from the second facial skin movements. For example, the reflections from the first area may be a stronger indicator of communication than the reflections from a second area because the facial skin micromovements determined from the reflections from the first area may be associated with a higher velocity, a higher displacement, or a higher other parameter indicating that the individual intents to convey information and/or the content of the information that the individual intends to convey. Consistent with disclosed embodiments, in the first example use case, when the first area is closer to the zygomaticus muscle, the first facial skin movements may reflect movements with a velocity on the order of one to ten pm/ms, and the second facial skin movements may reflect smaller movements, if any. In the second example use case, when the first area is closer to the risorius muscle, the first facial skin movements may reflect movements on the order of 0.5-2 mm, and the second facial skin movements reflect smaller movements, if any.

Consistent with some disclosed embodiments, the differences between the first facial skin movements and the second facial skin movements include differences of less than 100 microns. The term “differences of less than 100 microns” means that the changes between a first parameter that represents the first facial skin movements and a second parameter that represents second facial skin movements is less than 100 microns. In one example, the first parameter may be a magnitude of a first displacement change vector associated with the first facial skin movements and a second parameter may be a magnitude of a second displacement change vector associated with the second facial skin movements. A displacement change is a vector that quantifies the distance and direction changes between two measurements of the facial skin. For example, the differences between the first facial skin movements and the second facial skin movements include differences of less than 50 microns, less than 10 microns, or less than 1 micron. In other embodiments, the differences between the first facial skin movements and the second facial skin movements include differences of less than 1 millimeter. Accordingly, the determination that the reflections from the first area are a stronger indicator of communication than the reflections from the second area is based on the differences of less than 1 millimeter, less than 100 microns, less than 50 microns, less than 10 microns, or less than 1 micron.

Some disclosed embodiments involve, based on the determination that the reflections from the first area are a stronger indicator of communication, processing the reflections from the first area to ascertain the communication. The term “processing” refers to the act of performing operations or transformations on data or information to achieve a desired outcome. For example, processing may include manipulating, analyzing, or altering inputs in a systematic way to produce meaningful outputs. The term “processing reflections” means extracting information from signals representing the received reflections. For example, processing reflections may include actions, such as filtering, amplifying, modulating, and applying light reflection analysis as described elsewhere in this disclosure. Based on the determination that the reflections from the first area are a stronger indicator of communication, the reflections from the first area are processed to ascertain the communication. The term “ascertain the communication” means determining speech or facial expressions associated with non-verbal communication from facial movements, as described elsewhere in this disclosure. Consistent with the present disclosure, the reflections from the first area may be processed to create images of speckle patterns. Even at fast exposure times, such as 10 ms, the velocity of motion of the skin may be sufficient to make the speckle pattern change during each frame so that the bright pixels are blurred and washed out. The degree of speckle blur of a given spot in a given frame, as manifested by the loss of contrast in the image, for example, may be indicative of the instantaneous velocity of motion of the skin in the small area of the cheek under the spot. Processing the reflections from the first area may also include extracting quantitative image features from the images of speckle patterns. Vectors of these features, extracted from successive image frames, may be input to a neural network in order to ascertain the communication. Details of neural network architectures and training algorithms that may be used for this purpose are described elsewhere in this disclosure. An example feature that may be extracted for the purpose of ascertaining the communication may include speckle contrast. Any suitable measure of contrast may be used for this purpose, for example, the mean square value of the luminance gradient taking over the area of the speckle pattern. High contrast in the speckle pattern of a given spot from the first area may be indicative that the corresponding location of the cheek is stationary, while reduced contrast may be indicative of motion. The contrast decreases with increasing velocity of motion. Contrast features of this sort may be typically extracted from multiple spots distributed over the first area. Additionally, or alternatively, other features may be extracted from the speckle images and input to the neural network. Examples of such features may include total brightness of the speckle pattern and orientation of the speckle pattern, for instance, as computed by a Sobel filter. By way of one example, subvocalization deciphering module 708 in FIG. 7 may be used for processing the reflections from the first area to ascertain the communication.

Consistent with some disclosed embodiments, the communication ascertained from the reflections from the first area includes words articulated by the individual. “Ascertaining words articulated by the individual” refers to understanding words that are either vocalized or sub vocalized by the individual. By processing the signals resulting from reflections, words can be ascertained as discussed elsewhere herein. By way of example, the word “Hello” in FIG. 8 represents the words articulated by user 102A or user 102B that may be ascertained from the reflections from the first area.

Consistent with some disclosed embodiments, the communication ascertained from the reflections from the first area includes non-verbal cues of the individual. The term “non-verbal cues” refers to the various forms of communication that occur without the use of spoken words. Some examples of non-verbal cues may include facial expressions, body language, gestures, eye contact, tone of voice, postures, and other subtle signals that convey meaning in interpersonal interactions. For example, non-verbal cues, such as facial expressions, may be used to communicate basic emotions like happiness, sadness, anger, fear, surprise, and disgust. As discussed elsewhere in this disclosure, the at least one processor may determine a non-verbal cue by analyzing reflection signals representing facial skin micromovements in the first facial area. By way of example, the emoji in FIG. 8 represents the non-verbal cues that may be ascertained from the reflections from the first area.

Some disclosed embodiments involve, based on the determination that the reflections from the first area are a stronger indicator of communication, ignoring the reflections from the second area. In this context, the term “ignoring the reflections” means that the processing actions on the signals representing the received reflections from the second area are less than the processing actions on the signals representing the received reflections from the first area. In one embodiment, signals representing the received reflections from the second area may be filtered, amplified, and analyzed to determine the second facial skin movements, but some quantitative features may not be extracted because the communication may not be ascertained from signals representing the received reflections from the second area. In another embodiment which also involves “ignoring,” during a first time frame, reflections from both the first area and the second area may be processed to determine which area is closer to the zygomaticus muscle or the risorius muscle. Thereafter, during a subsequent second time frame, and upon determining that the first area is closer to the zygomaticus muscle or the risorius muscle, reflections from the second area may be automatically discarded.

According to some disclosed embodiments, ignoring the reflections from the second area includes omitting use of the reflections from the second area to ascertain the communication. The term “omitting use” refers to not using information associated with reflections from the second area when determining the meaning of the communication.

By way of example with reference to the two uses cases depicted in FIG. 8, reflection image 802A may be processed to ascertain communication 806 from first facial skin movements 804A associated with the zygomaticus muscle or the risorius muscle, and reflection image 802B may ignored, e.g., not used or omitted in ascertaining the communication. As depicted, the ascertained communication may include at least one word 806A (articulated silently or vocally by user 102A or user 102B) and/or at least one facial expression 806B that serves as an example of a non-verbal cue.

Some disclosed embodiments involve determining, based on differences between the first facial skin movements and the second facial skin movements, that the first area is closer than the second area to the subcutaneous tissue associated with cranial nerve V or with cranial nerve VII. The term “subcutaneous tissue” refers to the layer of tissue located beneath the skin and above the underlying muscles and bones. It is composed of fat cells, connective tissue, blood vessels, nerves, and other structures. Cranial nerve V, also known as the trigeminal nerve, is a sensory nerve for the face that control of jaw muscles. Cranial nerve VII controls facial expressions and carries taste sensation from the front of the tongue. Based on differences between the first facial skin movements and the second facial skin movements (as described above), a determination may be made that the first area is closer than the second area to the subcutaneous tissue associated with cranial nerve V or with cranial nerve VII.

Some disclosed embodiments involve operating a coherent light source in a manner enabling bi-mode illumination of the plurality of facial region areas. The term “coherent light source” may be understood as described elsewhere in this disclosure. Operating a coherent light source in this context refers to regulating, supervising, instructing, allowing, and/or enabling the coherent light source to illuminate at least part of a face. For example, the coherent light source may be controlled to illuminate a region of a face in a specific mode of illumination when turned on in response to a trigger. Bi-mode illumination refers to a capability of the coherent light source to illuminate an object using at least two different modes of illumination. The term “mode of illumination” refers to a specific configuration or settings of the coherent light source. Each of the two modes may be associated with different values of illumination parameters, such as light intensity, illumination pattern, pulse frequency, duty cycle, light flux. Light source 410 in FIG. 4 is one example of either a single mode or multi-mode (e.g., bi-mode) light source.

In some disclosed embodiments, a first light intensity of the first mode of illumination differs from a second light intensity of the second mode of illumination. In some disclosed embodiments, a first illumination pattern of the first mode of illumination differs from a second illumination pattern of the second mode of illumination. Light intensity refers to a brightness level of an illumination and an illumination pattern refers to an arrangement, distribution, or sequence of coherent or non-coherent light emitted from a source or reflected off a surface. The light pattern may be created by a specific design, shape, or configuration of light sources to create a particular visual or non-visual effect on the portion of the face. Examples of illumination patterns may include a grid of light spots having the same size, a grid of light spots having the various sizes, a single light spot, or any other pattern.

Some disclosed embodiments involve analyzing reflections associated with a first mode of illumination to identify one or more light spots associated with the first area, and analyzing reflections associated with a second mode of illumination to ascertain the communication. The term “identifying one or more light spots associated with the first area” means determining which of the light spots projected by the coherent light source are located in the first area. For example, identifying the one or more light spots associated with the first area may be implemented by comparing light intensity at a particular location with boundaries of the first area, based on image analysis of the face of the individual, or by any other processing method. In one example, the first mode of illumination may include a first illumination pattern (e.g., 64 light spots) and the second mode of illumination may include a second illumination pattern (e.g., 32 light spots). By way of example, with reference to the first example use case depicted in FIG. 8, the first mode of illumination may be used to identify eight light spots included within first area 800A associated with the zygomaticus muscle. Thereafter, the second mode of illumination (e.g., 4 light spots) may be used to illuminate first area 800A in a manner that enables ascertaining the communication from received reflections.

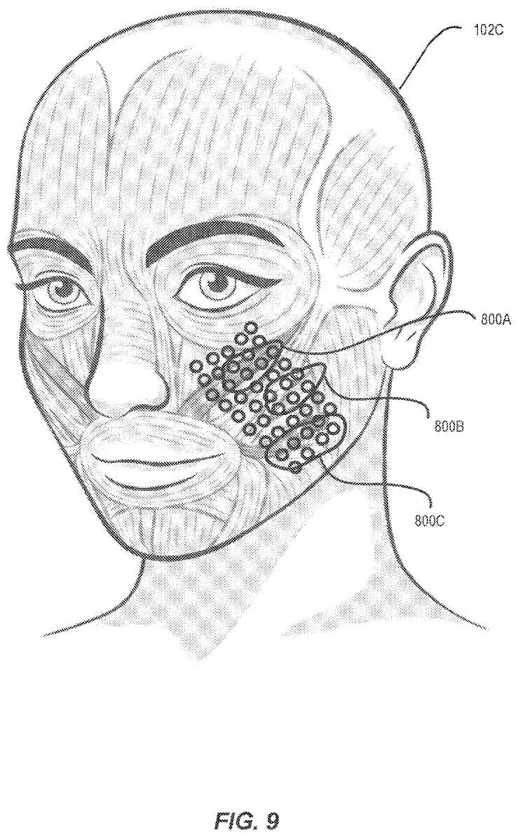

Consistent with some disclosed embodiments, the first area is closer than the second area to the zygomaticus muscle, and the plurality of areas further include a third area closer to the risorius muscle than each of the first area and second area. The terms “plurality of areas” and “closer to” may be understood as described elsewhere in this disclosure. By way of example with reference to FIG. 9, the plurality of facial areas 800 includes the first area 800A closer to the zygomaticus muscle than second area 800B, and a third area 800C closer to the risorius muscle than each of the first area 800A and second area 800B. In some disclosed embodiments, based on a determination that user 102C is engaged in silent speech, a processing device of the speech detection system may process the reflections from the first area 800A to ascertain the communication, and ignore the reflections from the second area 800B and the third area 800C. In other embodiments, based on a determination that user 102C is engaged in voiced speech, a processing device of the speech detection system may process the reflections from third area 800C to ascertain the communication, and ignore the reflections from the second area 800B and the first area 800A.

Some disclosed embodiments involve analyzing reflected light from the first area when speech is generated with perceptible vocalization (i.e., voiced speech) and analyzing reflected light from the third area when speech is generated in an absence of perceptible vocalization (i.e., silent speech). In other words, rather than monitoring the entire cheek and processing reflections from a plurality of areas, the speech detection system may process reflections received from a subset of the cheek area (e.g., only a few square millimeters or centimeters) in these two areas to detect both silent and voiced speech.

Furthermore, when the plurality of areas are illuminated by multiple light sources (e.g., an array of laser diodes) only the light sources that illuminate these two areas may be actuated, thus reducing power consumption. If a large movement of the speech detection system relative to the skin is detected, a different set of light sources may be actuated.

In some disclosed embodiments, different modes of processing may be applied to ascertain silent speech from voiced speech. For example, during silent speech, the first area being closer to the zygomaticus muscle may exhibit movements with a velocity on the order of one to ten pm/ms. Therefore, features of the images of the speckles themselves may change rapidly, and these features may be analyzed to generate an output. But during voiced speech, the third area being closer to the risorius muscle may exhibit movements on the order of 0.5-2 mm. Thus, the locations of the spots on the cheek may shift laterally due to the movement of the cheek. In this case, the lateral movements of the spots may be indicative of changes in the distance of the spots from the speech detection system, which may thus function as a sort of depth sensor. The two processing modes—speckle sensing and depth sensing—may be used individually in detecting silent and voiced speech, respectively. Alternatively, or additionally, these two processing modes may be used together to improve the precision and specificity of measurement, for example, by applying measurements of voiced speech by a given user to learn the patterns of microscopic movement that will occur in silent speech by the same user.

Some disclosed embodiments involve a wearable system for facilitating silent conversations. Facilitating refers to enabling, aiding, and/or assisting. For example, facilitating may refer to making something easier, enabling progress, or assisting in the achievement of a goal. A wearable system refers to an integrated set of hardware and/or software components designed for location on and/or connection to a human body. A wearable system may be associated with continuous data collection, monitoring, interaction, or augmentation of human capabilities, and may include one or more sensors, network interfaces, processors, memories, and/or power sources. Silent conversations refers to communications that occur in audibly or even if some noise is produced, communicated words are not understandable to those nearby. For example, silent communications may involve non-vocalized words, phrases, non-speech expressions, and/or gestures (e.g., face and/or hand gestures). A wearable system may detect facial skin micromovements to facilitate silent conversations. The wearable system may include any component, device of a group of components or devices operatively coupled together for performing a function.

Some disclosed embodiments involve a housing configured to be worn on a head of an individual. An individual may include a human user, a virtual assistant, and/or any other party and/or entity capable of engaging in a silent conversation. A housing configured to be worn on a head of an individual refers to any structure or enclosure designed for connection to or location on a human head, such as in a manner configured to be worn and/or donned by a user, as described elsewhere herein. While the item may be designed with a specific configuration or intended use, it is not limited to that arrangement and may be worn or utilized in alternative ways. Users may choose to apply, position, or wear the item in a manner that differs from the original design intent, depending on personal preference, situational needs, or functional adaptation. This flexibility allows for broader applicability without restricting the item to a single prescribed mode of use.

Some disclosed embodiments involve at least one sensor incorporated with the housing. A sensor refers to a component or device capable of detecting or measuring something. A sensor may also be a detector or sensing element. In some embodiments, a sensor may measure or detect a property and record, indicate, or otherwise respond to it. Some examples of sensors may include an optical sensors, acoustic sensors (e.g., a microphones and/or ultrasonic sensor), temperature sensors, touch sensors, current sensors, voltage sensors, motion sensors, and/or any other type of device or component for measuring a physical phenomenon. Some additional examples of sensors may include a visible light camera, an IR camera, and/or any other type of detector as described elsewhere herein. By way of non-limiting examples, a sensor may measure one or more of power, frequency, phase, pulse timing, pulse duration, and/or any other characteristics of electromagnetic waves and may generate an output relating to measured properties. Other non-limiting sensor examples are provided elsewhere herein. The at least one sensor may include a plurality of sensors and/or differing types of sensors, e.g., to detect differing forms of reflection and/or of scattering of light, secondary speckle patterns, different types of specular reflections, diffuse reflections, speckle interferometry, and any other form of light scattering. A sensor incorporated with a housing refers to a sensor mechanically connected to, and/or integrated with the housing. In some embodiments, a wearable system may include a light source for projecting coherent and/or non-coherent light towards a facial region of an individual, and a sensor incorporated with a housing may include a coherent and/or non-coherent light detector. At least one processor may analyze reflected light (e.g., using image processing techniques) and determine facial skin micromovements based on the analysis. In some embodiments, sensor may include an ultra-high resolution image sensor (e.g., more than 120 megapixel) and/or any other sensor capable of facial micromovement detection.

In some disclosed embodiments, the at least one sensor is configured to output signals indicative of communication-related neuromuscular activity of the individual. A signal refers to information in a form that enables transmission. For example, a signal may be encoded for transmission via a physical medium. Signals may include electrical or electromagnetic waves that carry information such as voice, video, or data. Signals can take various forms, including analog signals and digital signals. Other signal examples include radio signals, optical signals, microwave signals, infrared signals, ultrasonic signals, or any other wave or other conveyance that carries information. Non-limiting examples of signals include signals in the electromagnetic radiation spec mm (e.g., AM or FM radio, Wi-Fi, Bluetooth, radar, visible light, lidar, IR, Zigbee, Z-wave, and/or GPS signals), audio or ultrasonic signals, electrical signals (e.g., voltage, current, or electrical charge signals), electronic signals (e.g., as digital data), tactile signals (e.g., touch), and/or any other type of information encoded for transmission between two entities via a physical medium. To output signals refers to transmitting and/or conveying signals via a communication channel. The outputted signals may convey an electronic representation of a sensed measurement, and/or raw measurements sensed by the at least one sensor. An individual refers to a person, and may include a user of a wearable system for facilitating silent conversations.

Communication-related neuromuscular activity of an individual refers to coordinated interaction between a nervous system and a muscular system of the human individual that produces muscle contractions and/or movements associated with imparting and/or exchanging information. Neuromuscular activity may involve the transmission of electrical signals (action potentials) from motor neurons to muscle fibers at neuromuscular junctions. In some embodiments, the communication-related neuromuscular activity may include prevocalization muscle recruitment (i.e., subvocalization that occurs prior to an onset of vocalization is sometimes referred to herein as prevocalization), as described elsewhere herein. In some disclosed embodiments, communication-related neuromuscular activity of an individual may include facial skin micromovements, as described elsewhere herein.

By way of a non-limiting example, FIG. 1 shows an individual (e.g., user 102) wearing a wearable system for facilitating silent conversations (e.g., speech detection system 100). The wearable system may include wearable housing 110 worn on a head of user 102. The wearable system may include at least one sensor (e.g., see light detector 412 included in optical sensing unit 116, audio sensor 414 and/or additional sensors 418 in FIG. 4) incorporated with wearable housing 110 for outputting signals indicative of communication-related neuromuscular activity of user 102. For example, light detector 412 may detect facial micromovements as the individual thinks about a topic, and/or prepares to speak about a topic.

Some disclosed embodiments involve at least one processor, as described elsewhere herein. A wearable system may include one or more processors integrated therein (e.g., within an associated housing) and/or a network interface for communicating with one or more remote processors. For example, at least one processor integrated within a wearable system may communicate with a cloud server over a network (e.g., the Internet) to perform operations for facilitating silent conversations in a distributed manner. Some disclosed embodiments involve receiving signals. Receiving signals refers to obtaining, acquiring, and/or otherwise gaining access to transmitted information. Receiving may be performed on a wired and/or wireless channel. Receiving may involve connecting to or accessing a network, detecting an incoming signal at a receiver (e.g., an input port, an optical sensor, a microphone, and/or antenna), and/or formatting the signal for storage in memory as digital data. In some embodiments, receiving may include decoding information formatted for transmission through a medium to digital form and/or decrypting data for ingestion by at least one processor.

Some disclosed embodiments involve analyzing the received signals to determine substance of at least one conversation event associated with the individual. Analyzing the received signals refers to examining, interpreting, investigating, scrutinizing, and/or studying the received signals. To determine refers to arriving at an outcome. It may include, for example, undertaking an equality comparison to check whether two values are the same or are in a predetermined range. For example, the check may involve an equality operator like==in many languages (e.g., Python, JavaScript, C++). If the values are the same, the comparison evaluates to true; otherwise, it evaluates to false. Determining may additionally or alternatively include making a measurement, comparison, estimation, and/or calculation to arrive at a conclusive outcome. Determining may additionally or alternatively involve using Al to interpret or translate the signals into understandable communication, or may involve using historical correlations between prior similar signals and prior communicated phenomes, words, and/or phrases to understand meaning from current signals. A conversation event may include a form of communication between two or more entities (e.g., humans and/or virtual assistants) to exchange one or more thoughts, ideas, questions, and/or feelings. A conversation event may include one or more uttered words, phrases, and/or partially spoken words and/or phrases, and/or one or more facial movements, and/or engagement of facial muscles associated with a preparation to utter one or more words and/or phrases (e.g., pre-vocalized speech, subvocalization, and/or facial skin micromovements). Additionally or alternatively, a conversation may include text (e.g., typed in a chat box), a gesture (e.g., a facial and/or hand gesture), and/or any other form of communication. A substance of a conversation event associated with an individual refers to a core content, essence, and/or meaning of a conversation event associated with the individual. A substance of a conversation event may include a word, a phrase, an expression, an emotion, a warning, and/or any other core content of a conversation event.

Some disclosed embodiments involve generating at least one electronic output corresponding to the substance. Generating refers to producing, causing, and/or initiating. An electronic output corresponding to the substance refers to an electrical signal (e.g., a flow of charged particles having an associated voltage and current) encoding information in a manner to convey the substance of the conversation over a distance. Generating an electronic output may include emitting a command, emitting data, and/or causing any type of electronic device to initiate an action. An electronic output may include an audio file, text, graphics, and/or images for conveying one or more words and/or expressions associated with silent or prevocalized speech. An electronic output may be transmitted to a speaker associated with an earpiece configured to fit in an ear of an individual, to a graphical user interface for presenting visually, and/or to any other type of interface configured to convey information to an individual. In some embodiments, an electronic output may include an answer to a silently asked question by an individual to a virtual assistant. In some embodiments, an electronic output may include synthesized speech (e.g., artificial production of human speech). In some embodiments, a textual presentation and an audio presentation of silent or prevocalized speech may be converted to electronic outputs and presented to an individual concurrently. In some embodiments, an electronic output may include data exchanged with a communications device of the individual (e.g., a smartphone, a tablet, a smartwatch, a personal digital assistant, a desktop computer, a laptop computer, an Internet of Things (IoT) device, a dedicated terminal, a wearable communications device, and any other device that enables data communications).

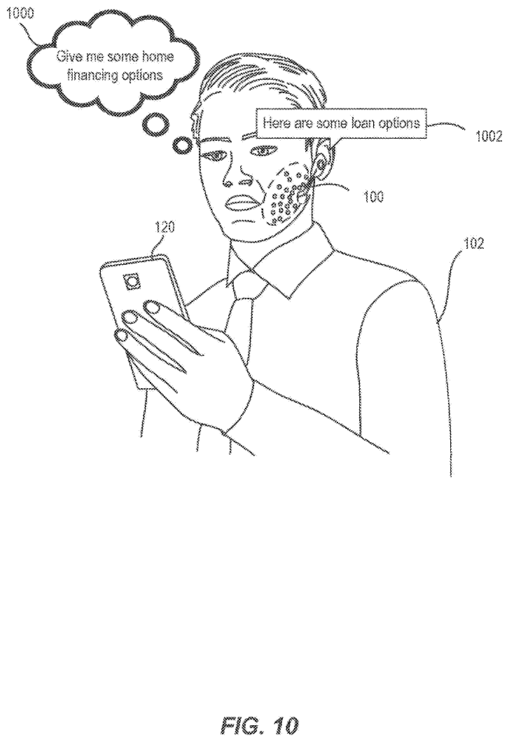

By way of a non-limiting example, reference is made to FIG. 10, which is a schematic illustration of user 102 wearing a wearable system (e.g., speech detection system 100) for facilitating silent conversations, consistent with some embodiments of the present disclosure. The wearable system may include at least one processor integrated therewith (e.g., see at least one processing device 400 in FIG. 4). The at least one processor may analyze received signals (e.g., detected via optical sensing unit 116 and/or additional sensors 418) determine the substance of at least one conversation event 1000 associated with the individual. The at least one processor may generate at least one electronic output 1002 corresponding to substance of conversation event 1000. For example, conversation event 1000 may include an inquiry by the individual about financing options for purchasing a home. User 102 may vocalize conversation event 1000 or express conversation event 1000 as silent speech detectable by speech detection system 100. In response, the at least one processor may generate electronic output 1002 presenting differing financing options for purchasing a home.

At times, while conversing on a first topic, a second topic may arise in a person's thoughts and/or as pre-vocalized and/or subvocalized speech. For example, the first topic may remind the individual to address the second topic. Embodiments are disclosed for a wearable system for providing follow up to non-vocalized speech pertaining to a second topic that arose during a conversation about the first topic.

In some disclosed embodiments, at least one conversation event includes a first conversation event during a first time period and involving a first topic, and a second subsequent conversation event during a second time period and involving a second topic. A time period refers to a duration and/or interval of time, and may be measurable in units (e.g., minutes, seconds, microseconds, and/or any other unit of time). A first time period may precede a second time period. A second time period may immediately follow a first time period, or may follow a third time period separating the first time period and the second time period. The first time period and second time period may have similar or differing durations. A topic refers to a subject or theme of a conversation and/or discussion at a particular point in time. A conversation may drift to differing topics over time such that a first topic discussed during a first time period may differ from a second topic discussed during a second time period. The first topic and second topic may be related, but not necessarily. For example, the first and second topics may be related by an association particular to an individual (e.g., based on a history and/or context particular to the individual and/or to particular point in time). Consequently, the association may be difficult to subsequently recall and/or generate.

In some disclosed embodiments, the received signals associated with the first conversation event constitute first signals, wherein the at least one processor is further configured to receive, during the subsequent second time interval, second signals representing speech on the second topic, and wherein the at least one electronic output includes, following the second subsequent conversation event a reminder of the first topic determined based on the first signals. First and second signals refers to differing sets and/or series of signals. The first and second signals may be the same signal type (e.g., optical signals and/or electromagnetic wave signals) or differing signal types, and may convey differing information. First and second topics refers to differing topics. The first and second topics may be directly and/or indirectly related. In some embodiments, there is no apparent relation between the first topic and the second topic. For example, the second topic may arise randomly and/or in response to an external stimulus (e.g., a received message, phone call, and/or piece of news). At least one processor associated with a wearable system for facilitating silent conversations may continually receive signals associated with a conversation on differing topics overtime. The at least one processor may analyze the received signals over time to identify a first topic discussed during a first time period, followed by a second topic discussed during a second time period after the first time period. Following the second subsequent conversation event refers to after detection of a conversation event (as described previously) associated with the second topic.

A reminder of the first topic determined based on the first signals refers to a notice, a cue, and/or hint to refresh a memory using the received first signals. For instance, at least one processor may use the first signals to store data associated with the first topic in memory. Upon determining that the individual is currently discussing the second topic, the at least one processor may transmit a cue reminding the individual during the second time period of the first topic discussed during the first time period. By way of example, an individual may discuss a menu during a first time period, and discuss a shopping list during a second time period. At least one processor may use signals associated with the discussion of the menu, received during the first time period, to remind the individual of the menu while discussing the shopping list during the second time period.

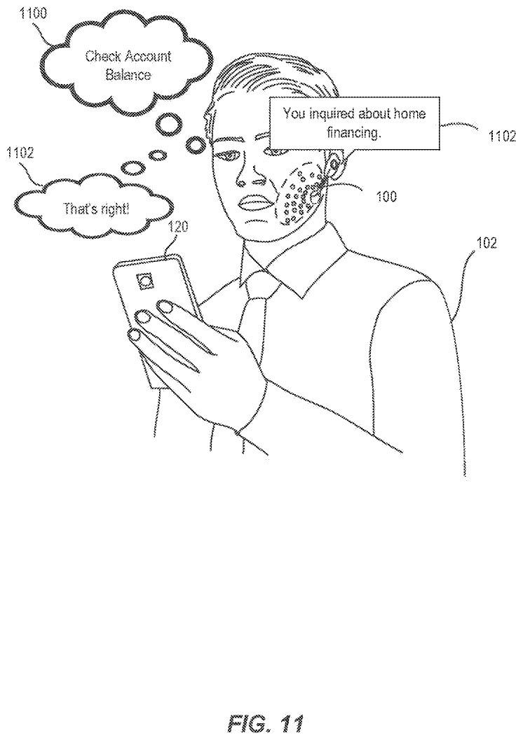

By way of a non-limiting example, reference is made to FIG. 11, which is another schematic illustration of user 102 wearing a wearable system (e.g., speech detection system 100) for facilitating silent conversations, consistent with some embodiments of the present disclosure. FIG. 11 is substantially similar to FIG. 10 with the notable difference that FIG. 10 is associated with a first time period during occurrence of first conversation event 1000 and FIG. 11 is associated with a second time period during occurrence of a second conversation event 1100. Thus, the at least one conversation event may include first conversation event 1000 during the first time period and involving a first topic (e.g., financing options for purchasing a home in FIG. 10), and second subsequent conversation event 1100 during the second time period and involving a second topic (e.g., to check an account balance). For example, the first topic of financing a home raised during the first time period (see FIG. 10) may trigger the second topic to check the account balance during the second time period (see FIG. 11). The association between the first topic and second topic may be indirect, non-obvious, and/or not readily apparent, and may thus be difficult to subsequently recall. In some embodiments, the second topic may arise in response to an external stimulus (e.g., a message received via mobile communications device 120) and may be unrelated to the first topic.

The received signals associated first conversation event 1000 may constitute first signals (e.g., including first instances of light reflections 300 shown in FIG. 5B detected during the first time period and associated with home financing options). At least one processor (e.g., processing device 400 and/or processing device 460 of FIG. 4) may receive, during the subsequent second time interval, second signals representing speech on the second topic (e.g., second instances of light reflections 300 detected during the second time period and associated with checking the account balance). The at least one electronic output 1002 may include, following second subsequent conversation event 1100, a reminder of the first topic determined based on the first signals (e.g., a reminder of the inquiry on home financing options).

In some disclosed embodiments, at least one of the first conversation event and the second subsequent conversation event involves silent speech, and at least one of the first signals and the second signals capture the silent speech. Silent speech refers to movement of facial skin or muscles in an absence of perceptible vocalization but which nevertheless conveys speech-related information, as described elsewhere herein. Signals capturing silent speech refers to signals recording, preserving, conveying, and/or storing information associated with non-vocalized and/or subvocalized speech. For example, during a first time period, an individual may perform a vocalized conversation on a first topic (e.g., a sports game) while performing subvocalize speech associated with a second topic (e.g., a traffic forecast). To avoid potential loss of thoughts associated with the second topic, a speech detection system may track the subvocalized speech expressed during the first time period, and store associated information in memory. During the second time period, upon detecting the individual conducting a conversation about the second topic (the traffic forecast), the at least one processor may notify the individual that the second topic arose as subvocalized speech in the conversation on the first topic (the sports game) during the first time period. As another example, during a first time period, an individual may perform subvocalize speech associated with a first topic (e.g., a medical appointment). A speech detection system may track the subvocalized speech expressed during the first time period, and store associated information in memory. During the second time period, upon detecting the individual conducting a vocalized conversation about a second topic (e.g., a car repair), the at least one processor may notify the individual of the first topic (e.g., medical appointment) that arose as sub vocalized speech during the first time period.

In some disclosed embodiments, both the first conversation event and the second subsequent conversation event involve silent speech, and both the first signals and the second signals capture the silent speech from both the first conversation event and the second subsequent conversation event. Thus, at least one processor may detect a first silent speech during the first time period in association with the first conversation event and detect a second silent speech during the second time period in associated with the second conversation event. The first silent speech and/or second silent speech may be accompanied by vocalized speech, but this is not required. In other words, the wearable system may determine that the first silent speech is associated with a first topic (a medical appointment) and the second silent speech is associated with a second topic (a work meeting), without the individual uttering any words or sounds. At least one processor may store data associated with the first silent speech and the second silent speech in memory for subsequently reminding the individual of the first topic and/or the second topic.

By way of a non-limiting example, in FIGS. 10 and 11, in some embodiments, at least one of first conversation event 1000 and second subsequent conversation event 1100 involves silent speech. At least one of the first signals and the second signals capture the silent speech. For instance, the first and second signals may include first and second instances of light reflections 300 (see FIG. 5B) reflected off the face of user 102 and detected by optical sensing unit 116 (see FIG. 4). In some embodiments, both first conversation event 1000 and second subsequent conversation event 1100 involve silent speech and both the first signals and the second signals capture the silent speech from both first conversation event 1000 and second subsequent conversation event 1100. For instance, the first and/or second instances of light reflections 300 may capture facial skin micromovements by user 102 associated with pre-vocalized speech.

In some disclosed embodiments, at least one processor is configured to receive input from the individual, and based on the input, identify an intent of the individual to return to the first topic. To receive input from an individual refers to detecting, obtaining, and/or accessing one or more signals caused by the individual. This may occur, for example, via a user interface presented to the individual. The user interface may include a touch screen, an optical sensor, a microphone, a virtual and/or physical keyboard, and/or any other type of user interface for receiving information from a user. An intent of an individual to return to the first topic refers to a goal, objective, and/or desire to revert and/or recall the first topic. Identifying an intent of the individual based on the input refers to inferring or understanding the user's intent from the input. It may include, for example, extracting from the input information from which an intent may be understood (e.g., audible or silent speech recognition/interpretation), or it may simply involve receiving anon-audible/non-silent speech command (e.g., through a touch screen). By way of another example, the input may include a gesture associated with the first topic, and/or a spoken and/or typed word. The first topic may be associated with scheduling an appointment to renew a vehicle registration, and the input may include a pointing gesture to the vehicle to be registered. At least one processor may receive image data of the pointing gesture and determine an intent to schedule the appointment. As another example, the first topic may be an approaching birthday for a partner, and the input may include non-vocalized speech associated with the name of the partner. At least one processor may receive data indicative of the non-vocalized speech and send a reminder to the individual of the exact date of the approaching birthday of the partner.

By way of a non-limiting example, in FIGS. 10-11, at least one processor (e.g., processing device 400 and/or processing device 460 in FIG. 4) may receive input 1102 from user 102. Based on input 1102, the at least one processor may identify an intent of user 102 to return to the first topic. For example, input 1102 may include light reflections 300 associated with a non-vocalized phrase “that's right”.

In some disclosed embodiments, a reminder includes at least one of a summary of a nonvocalized speech on the first topic, a recitation of a portion of a non-vocalized speech on the first topic, or a detail related to the first time period. A summary of a non-vocalized speech on the first topic refers to an outline, digest, and/or recap of the non-vocalized speech on the first topic. In some embodiments, at least one processor may enlist a Large Language Model (LLM) to generate a summary of the first topic based on discerned non-vocalized words expressed by the individual. A recitation of a portion of a non-vocalized speech on the first topic refers to a narration and/or audible presentation of some of the non-vocalized speed. For example, at least one processor may convert words associated with a portion of the non-vocalized speech to electrical signals encoded for audio rendition and transmit the electrical signals to a speaker to audibly render the portion (or signals may be sent to a visual display for textual presentation. A detail related to the first time period refers to information associated with and/or reminiscent of the first time period. Such a detail may include a word or words related to a topic discussed, a location (e.g., an office, a home, a restaurant, or outdoors), a specific hour, a portion of a day (e.g., morning, afternoon, or evening), a day of the week, a context, an object and/or word, an environmental condition (e.g., a heat wave, rain), and/or any other information and/or cue reminiscent of and/or associated with the first time period. Such a detail may serve as a cue for the first topic. For example, a commuter may wish to recall what they were thinking about while travelling home on the train.

In some disclosed embodiments, the electronic output includes a private presentation of the first topic delivered to the individual. A private presentation refers to a discrete and/or confidential presentation. A private presentation may be consumed exclusively by the individual and may be unavailable to others. For example, at least one processor may render an audio output via an earbud worn by the individual, such that only the individual may hear the output. As another example, at least one processor may output text and/or a graphic element on a display of a wearable device (e.g., smart glasses) such that only the individual may see the output.

By way of a non-limiting example, in FIGS. 10-11, the reminder (e.g., at least one electronic output 1102) may include at least one of a summary of a non-vocalized speech on the first topic, a recitation of a portion of a non-vocalized speech on the first topic, or a detail related to the first time period. For instance, the reminder may include an audible presentation of the words “You inquired about home financing” as a summary of non-vocalized speech on the first topic. In some embodiments, electronic output 1102 may include a private presentation of the first topic delivered to user 102, for instance, as an audio rendition of the reminder delivered to a speaker worn inside the ear of user 102. Additionally or alternatively, the reminder may include text rendered on a display of mobile communications device 120.

Differing individuals may speak in differing speech styles. For example, a 70-year-old man versus a 12-year-old girl use different vocabularies, have differing communication styles, and often prefer to interact with those who communicate similarly. Embodiments are disclosed for a wearable system to learn a speaking style of an individual and adjust the speaking style of an associated voice response system to customize vocalized interactions.

In some disclosed embodiments, the at least one processor is further configured to determine from the at least one conversation event a personal speaking style of the individual and to audibly present to the individual the electronic output in a manner corresponding to the determined personal speaking style. A personal speaking style of an individual refers to a distinctive way an individual may communicate verbally. A personal speaking style may be associated with one or more individual speaking attributes, such as a choice and/or preference of words and/or expressions, a tone of voice, a volume, a speed, a flow, pauses, emphasis, an inflection, an accent, a pitch, a gender, an age, a pacing, rhythm, body language, a mood, a context, an emotion, and/or any other characteristic affecting speech. To determine from the at least one conversation event a personal speaking style of the individual refers to analyzing a signal associated with the conversation event to identify one or more individual speaking attributes. In some embodiments, at least one processor may enlist artificial intelligence to determine the personal speaking style of the individual. In some embodiments, at least one processor may use a history of speech excerpts of the individual to determine the personal speaking style. To audibly present to the individual the electronic output in a manner corresponding to the determined personal speaking style refers to rendering the electronic output acoustically to cause the output to simulate the personal speaking style of the individual. For example, at least one processor may apply one or more attributes of the personal speaking style to modulate a signal associated with the electronic output and transmit the modulated signal to a speaker, to thereby audibly reproduce the personal speaking style of the individual.

In some disclosed embodiments, the electronic output includes a response to a query presented in a manner mimicking an aspect of the determined personal speaking style. A response to a query refers to a reply and/or answer given to a question and/or request. The query may be received from the individual wearing the wearable system, or from a different entity conversing with the individual. Determining a response to a query may include parsing and/or interpreting the query to determine the intent of the query, and/or the information requested, determining any rules, permissions, and/or filters associated with the requested information, executing the query on a data structure, retrieving a response to the query, and/or formatting the response for presenting to a user. Mimicking an aspect of the determined personal speaking style refers to copying, simulating, and/or impersonating the determine speaking style of the individual. This may include formatting and/or encoding the response to the query as an audio signal, and applying the one or more of the identified individual speaking attributes to the audio signal such that at least some of the attributes of an audible rendition of the response correspond to at least some of the identified speaking attributes of the individual. For example, if the individual is an elderly woman who speaks with a northeastern dialect, the response to the query may mimic an elderly woman speaking with the northeastern dialect.

In some disclosed embodiments, at least one processor is configured to determine a context for the query, and the manner in which the response is presented is determined based on the determined personal speaking style and the determined context. A context for a query refers to associated information and/or circumstances providing meaning to the query. A context for a query may be used to determine how a query may be interpreted and/or processed, and may indicate an intent and/or type for the query, a permission and/or role of an individual making the query, a data structure and/or schema targeted by the query and/or one or more filters and/or condition, associated therewith, and/or any other information that may be used to interpret and/or process the query. Determining a context for a query may include collecting and/or analyzing metadata associated with the query. Such metadata may include an identity of the entity (e.g., another individual and/or an application) submitting the query, a location and/or environment where the query is made, background noises and/or sounds, images associated with an environment where the query is made, words, phrases, and/or tokens included in the query, content of one or more previously submitted queries and/or responses thereto, one or more vocalized and/or non-vocalized words and/or phrases preceding the query, and/or any other information associated with a context for a query. Determining a manner for presenting the response based on the determined personal speaking style and the determined context may include analyzing the personal speaking style and the determined context to determine a response to the query, and/or selecting one or more identified individual speaking attributes for applying to an audio signal encoding the response. For example, if the individual is a middle aged male and the context is work-related, the response to the query may mimic the middle aged male employee using a personal speaking style appropriate for a professional context, e.g., a slow and steady tone and/or rhythm. By contrast, if the individual is the same middle aged male and the context is online gaming, the response to the query may mimic the middle aged male using a personal speaking style suitable online gaming, e.g., including slang terms that may be unsuitable in a professional context and using a faster, more amplified tone and/or rhythm.

In some disclosed embodiments, the aspect of the personal speaking style includes at least one of a typical speech cadence, atypical speech tone, atypical speech intonation, or atypical voice volume. A typical speech cadence refers to a common and/or expected rhythm, pace, and/or flow of spoken language. Speech cadence may indicate how speech speeds up and/or slows down, and may include pauses, stresses, and/or emphasis on certain words and/or phrases. A typical speech intonation refers to a common and/or expected pattern of pitch variations in spoken language. Speech intonation indicate how a voice rises and falls while speaking, and facilitate in conveying meaning, emotion, and/or intent. A typical voice volume refers to a common and/or expected loudness and/or intensity of spoken language. Voice volume may range from soft (e.g., barely audible and/or whispering) which may range from 30 to 50 decibels (dB), normal conversation (e.g., for face to face communication) which may range from 50-70 dB, loud (e.g., for public speaking and/or for overcoming background noise) which may range from 70-85 dB, and/or very loud (e.g., shouting and/or yelling) which may range upwards of 85 dB.

By way of a non-limiting example, in FIG. 10, at least one processor (e.g., processing device 400 and/or processing device 460 of FIG. 4) may determine from at least one conversation event 1000 a personal speaking style of user 102. The at least one processor may audibly present to user 102 electronic output 1002 in a manner corresponding to the determined personal speaking style. For instance, user 102 may have a Southern accent, and electronic output 1002 may be presented using a Southern accent. In some embodiments, electronic output 1002 may include a response to a query presented in a manner mimicking an aspect of the determined personal speaking style. For instance, at least one conversation event 1000 may include a query for home financing options, and the electronic output 1002 may include details of home financing options articulated in a Southern accent. In some embodiments, the at least one processor may determine a context for the query (e.g., home financing), and the manner in which the response is presented may be determined based on the determined personal speaking style (e.g., a Southern accent) and the determined context (e.g., using atone suitable for a banker). In some embodiments, the aspect of the personal speaking style includes at least one of a typical speech cadence, a typical speech tone, a typical speech intonation, or a typical voice volume.

Keyboard-driven virtual assistants may identify when an individual submits a query by identifying submission of the Enter key. However, a voice-operated virtual assistant may require a non-keyboard cue to identify when a query has been submitted. Embodiments are disclosed for a voice-driven virtual assistant capable of attributing meaning to pauses in speech, and identifying when a specific pause indicates that the individual has submitted a query and is waiting for a response.

In some disclosed embodiments, the at least one conversation event involves a query to a virtual assistant and a pause during an articulation of the query, and the at least one processor is configured to determine whether the pause is attributable to articulation delay or query completion. A virtual assistant refers to a software-based agent designed to assist human users. A virtual assistant may perform tasks, answer questions, and/or manage information through natural language interaction via voice, text, or graphical interfaces. For example, a user may speak a command to a virtual assistant, which the virtual assistant may parse, analyze, and/or interpret and carry out one or more tasks in response. Such tasks may include playing music, writing and/or editing text, sending a text message, adding an item to a shopping list, answering a query, writing software, and/or any other task. In some embodiments, a virtual assistant may include an Artificial Intelligence (AI) assistant, such as an application program that understands natural language voice commands and completes tasks for the user in response. A virtual assistant may reside locally (e.g., as software instructions stored in a memory of a wearable system) and/or remotely (e.g., with a cloud service connected to a wearable system). Articulation refers to a vocalization, an utterance, and/or an enunciation of one or more words. A pause during an articulation of a query refers to an interval, a delay, and/or break during vocalization of a query. An articulation delay refers to an interval and/or break while articulating one or more words and/or phrases. An articulation delay may be due to a breath pause and/or a thinking pause allowing a speaker to formulate thoughts and/or choose words, a grammatical pause aligning with punctuation, a pause for emphasis, an interactive pause permitting another party of a conversation to speak, and/or any other type of conversational pause. A query completion refers to a conclusion and/or finalization when articulating a question and/or query. A pause due to query completion may indicate to a virtual assistant to interpret the query and retrieve a response. Attributable to something refers to accredited to, traceable, and/or caused by something. To determine whether a pause is attributable to articulation delay or query completion refers to identifying when a pause occurs in the middle of an articulation of a query (e.g., before the query is completely articulated), versus when a pause occurs at the end of an articulation of a query (e.g., once the query is completely articulated). For example, at least one processor may use a combination of linguistic cues, timing thresholds, and/or contextual analysis to distinguish between differing types of pauses in an articulation of a query. At least one processor may analyze the syntax and/or semantics of a spoken input, and if the utterance forms a complete sentence and/or question, the at least one processor may associate a pause with query completion. As another example, at least one processor may identify a shorter phrase following a prior longer phrase and assign a shorter time threshold for a pause attributable to completion of the shorter phrase and a longer time threshold for a pause attributable to completion of the longer phrase. At least one processor may use one or more timing rules (e.g., adapted to a particular user's speaking style) to detect pauses, where a short pause (e.g., less than 0.5 seconds) may indicate ongoing speech and a longer pause (e.g., more than 1 second) may signal the end of a query. In some embodiments, at least one processor may identify falling intonation as indicative of the end of a statement and/or query, and a rising intonation as indicative of a question or an unfinished sentence. A software agent may use a context for a query to identify when a query is complete, or if to expect additional query-related speech. In some embodiments, a virtual assistant may prompt a user to confirm when a query is complete.

In some disclosed embodiments, when the at least one processor determines that the pause is attributable to an articulation delay, the at least one processor is configured to withhold transmission of the query to the virtual assistant. To withhold transmission of a query to a virtual assistant refers to suspend, refrain, and/or postpone sending a query to the virtual assistant for processing. At least one processor may withhold transmission of a query until an indication is received that the query is complete. For example, the at least one processor may store the query and/or a portion thereof in a buffer and/or queue until receipt of an indication that the query is complete. In some disclosed embodiments, when the at least one processor determines that the pause is attributable to an articulation delay, the at least one processor is configured to send an indication to the virtual assistant that the query is incomplete. To send an indication to a virtual assistant that the query is incomplete refers to transmitting a signal to the virtual assistant that additional information may be required before the query may be processed. For instance, at least one processor may transmit an indication to the virtual assistance to wait to receive one or more additional words, portions of words, and/or phrases before processing the query. Consequently, the virtual assistant may postpone parsing and/or interpreting the query until a determination may be made that the query is complete.

In some disclosed embodiments, when the at least one processor determines that the pause is attributable to query completion, the at least one processor is configured to send the query to the virtual assistant. To send the query to a virtual assistant refers to transmit the query to the virtual assistant, e.g., over a wired and/or wireless communication link. Sending the query to a virtual assistant may include sending an electronic signal encoding a vocalized rendition of the query, and/or sending a textualized and/or tokenized rendition of the vocalized rendition. The virtual assistant may be implemented as executable software instructions locally (e.g., using at least one processor integrated with the wearable system) and/or remotely (e.g., at a cloud server). Thus, sending a query to a virtual assistant may include transmitting at least a portion of the query to a cloud server over a network, and the transmitting at least a portion of the query locally, e.g., via a local Wi-Fi and/or Bluetooth channel and/or a local bus internal to the wearable system.

In some disclosed embodiments, the at least one processor is further configured to determine a conversation context, and to determine a cause of the pause from the determined conversation context. A conversation context refers to a topic and/or subject matter of a discourse between two or more parties. A conversation context may be based on previous exchanges between the parties, intent, tone, style, word choice, environment, platform, roles of one or more participants, cultural and/or linguistic norms, a session history, user preferences, recognized keywords and/or tokens, a current task and/or workflow, and/or any other information indicative of context. Determining a conversation context may include collecting data associated with the conversation, e.g., including the identity of the parties to the conversation and/or associated roles and/or relationships therebetween, locations of the parties, a history of conversations between the parties, key words, the identity and/or type of devices used to engage in the conversation, a type of communication channel used to exchange data for the conversation (e.g., a private virtual network or VPM and/or other dedicated channel), and/or any other information that may be used to assess a context of a conversation. For example, at least one processor may determine a work-related context for a conversation occurring over a VPN dedicated to an employer, and a gaming-related context for a conversation occurring over a VPN dedicated to a gaming platform. In some embodiments, at least one processor may use artificial intelligence to determine a context of a conversation.

By way of a non-limiting example, in FIG. 10, at least one conversation event 1000 may involve a query to a virtual assistant (e.g., implemented as software executed on remote processing system 450 and/or mobile communications device 120) and a pause during an articulation of the query. The at least one processor (e.g., processing device 400 and/or processing device 460 in FIG. 4) may determine whether the pause is attributable to articulation delay or query completion. For instance, the at least one processor may analyze the grammar of the non-vocalized expression “Give me some home financing options” and based on the grammar, determine that the query is complete. As another example, the at least one processor may analyze facial skin micromovements to determine that the query is complete (e.g., based on mouth and/or eye motion). In some embodiments, when the at least one processor determines that the pause is attributable to an articulation delay, the at least one processor may withhold transmission of the query to the virtual assistant. In some embodiments, when the at least one processor determines that the pause is attributable to query completion, the at least one processor may send the query to the virtual assistant on remote processing system 450 via network interfaces 420 and 456. In some embodiments, the at least one processor may determine a conversation context (e.g., home financing). The at least one processor may determine a cause of the pause from the determined conversation context (e.g., user 102 may be waiting to receive a response to the query on home financing options).

When parties engage in a conversation, the parties may take turns to speak. Embodiments are disclosed for detecting facial micromovements associated with taking a turn and/or waiting for a turn to speak.

In some disclosed embodiments, the at least one conversation event is indicative of turn taking dynamics between the individual and a participant, and the electronic output by the least one processor reflects the turn-taking dynamics. A participant refers to a party, e.g., in a conversation may include a human (e.g., an individual and/or a user), a virtual assistant, a robot, and/or any other agent and/or entity capable of engaging in conversation. Turn-taking dynamics between the individual and a participant refers to how parties to a conversation alternate roles between speaker and listener. During a conversation, the parties may take turns to speak, listen, respond, and/or pause. Such dynamics may maintain conversational flow, mutual understanding, and/or social harmony. Some examples of turn taking dynamics may include starting a sentence, ending a sentence, taking a turn to speak, yielding a turn to speak, attempting to interrupt, expressing readiness to listen, requesting confirmation, and/or concluding a point. For instance, at least one processor may detect when an individual is taking a turn to speak by detecting that the individual has started a sentence, asked a question, and/or signaled intent to speak, for instance using a hand gesture and/or by engaging facial muscles (e.g., by opening the mouth and/or eyes). At least one processor may detect when the individual is yielding a turn to speak by detecting falling intonation, a pause, and/or use of a hand gesture and/or engagement of facial muscles (e.g., by closing the mouth and/or relaxing the eyes). Additionally or alternatively, at least one processor may use speech recognition to detect pauses and/or sentence boundaries, timing thresholds for pauses, context awareness, and/or any other cue indicative of turn-taking dynamics. In some embodiments, at least one processor may use artificial intelligence to identify turn-taking dynamics.

By way of a non-limiting example, reference is made to FIG. 12, which is a schematic illustration of two individuals (e.g., user 102 and user 1200) wearing wearable systems 100 and 1202, respectively, for facilitating silent conversations, consistent with some embodiments of the present disclosure. Wearable system 1202 may be substantially similar to wearable system 100. Users 102 and 1200 may converse directly via voice interaction, and/or via wearable systems 100 and 1202. For example, users 102 and 1200 may be located in an area where speaking audibly may be restricted and may communicate via non-vocalized speech using wearable systems 100 and 1202. Thus, wearable system 100 may detect non-vocalized speech expressed by user 102 and may present a text rendition of the non-vocalized speech on a mobile communications device 1204, and/or an audio rendition of the non-vocalized speech via a speaker included in wearable system 1202. Similarly, wearable system 1202 may detect non-vocalized speech expressed by user 1200 and may present a text rendition of the non-vocalized speech on a mobile communications device 120, and/or an audio rendition of the non-vocalized speech via a speaker included in wearable system 100.

At least one processor (e.g., processing device 400 and/or processing device 460 of FIG. 4 associated with in wearable system 1202) may determine substance of a first conversation event 1206 expressed by user 1200, and at least one processor (e.g., processing device 400 and/or processing device 460 associated with wearable system 100) may determine substance of a second conversation event 1208 expressed by user 102. For instance, wearable system 1202 may detect a non-vocalized expression by user 1200 inviting user 102 to meet for coffee as first conversation event 1206, and wearable system 100 may detect a non-vocalized expression by user 102 accepting the invitation as second conversation event 1208. At least one processor of wearable system 1202 may determine the substance of first conversation event 1206, generate an electronic output 1210 corresponding to the substance, and transmit electronic output 1210 as an audio file to wearable system 100 for playing via speaker 404 forbearing by user 102. Electronic output 1210 may include an audible rendition of the non-vocalized expression of user 1200 (e.g., corresponding to first conversation event 1206) detected by wearable system 1202 and played for user 102 by wearable system 100. Similarly, at least one processor of wearable system 100 may determine the substance of second conversation event 1208, generate an electronic output 1212 corresponding to the substance, and transmit electronic output 1212 as an audio file to wearable system 1202 for playing via speaker 404 for hearing by user 1200. Electronic output 1212 may include an audible rendition of the non-vocalized expression of user 102 (e.g., corresponding to second conversation event 1208) detected by wearable system 100 and played for user 1200 via speaker 404 of wearable system 1202.

Conversation event 1206 and conversation event 1208 may be indicative of turn-taking dynamics between the user 102 and user 1200, and electronic outputs 1210 and 1212 by the least one processor may reflect the turn-taking dynamics. Electronic outputs 1210 and 1212 may be part of a non-vocalized exchange between user 102 and user 1200, each taking turns to respond to the communication of the other.

In some disclosed embodiments, the participant is another individual or a large language model. A large language model (LLM) refers to an artificial intelligence system designed to understand and generate human-like language. An LLM may be trained on vast amounts of text data and may use deep learning techniques, such as transformer architectures to process and produce natural language. An LLM may statistically simulate an understanding of context, grammar, and meaning, and may generate coherent text, summarize information, translate languages, and/or respond to queries. An LLM may use unsupervised and/or semi-supervised learning on diverse sources of text (e.g., books, websites, and/or articles), and may learn patterns, relationships, and/or language structures. Another individual refers to another human party.

By way of a non-limiting example, in FIG. 12, the participant (e.g., user 1200) may be another individual. In FIG. 11, the participant may include an LLM (e.g., incorporated in a virtual assistant implemented as executable software on remote processing system 450 (see FIG. 4).

Successful communication between a human user and an LLM may require several attempts by the user until the LLM identifies a relevant context and/or suitable response to the user's query. Embodiments are disclosed to improve communication with an LLM using non-verbal Interaction.

In some disclosed embodiments, the at least one conversation event is indicative of a reaction of the individual to a virtual assistant, and the at least one processor is further configured to provide the electronic output to the virtual assistant for adjusting a communication manner of the virtual assistant with the individual. A reaction of the individual to a virtual assistant refers to the behavioral and/or emotional response of the individual consequent to interacting with the virtual assistant. The reaction of the individual may indicate how the individual perceives, engages, and/or evaluates the performance and/or information received from the virtual assistant. For example, an angry and/or frustrated facial expression may indicate a dissatisfied reaction to a virtual assistant, whereas a calm and/or pleased facial expression may indicate a satisfied reaction to the virtual assistant. Adjusting refers to altering, changing, and/or modifying. A communication manner of a virtual assistant refers to an interactional behavior of the virtual assistant, such as the dialogue strategy employed, and/or linguistic presentation provided by the virtual assistant. A communication manner of a virtual assistant may affect how the virtual assistant interprets a query and may affect a type of response provided to the query. To provide electronic output to a virtual assistant for adjusting a communication manner of the virtual assistant with an individual refers to transmitting a signal to the virtual assistant to change how the virtual assistant communicates. For example, the signal may be configured to modify the strategy employed by the virtual assistant when generating conversational feedback to the individual. For instance, a virtual assistant may erroneously interpret a work-related query as being associated with a non-work related context, and may provide feedback for the non-work-related context. At least one processor may identify a dissatisfactory conversation event to the feedback (e.g., a frown) and transmit a signal indicative of the dissatisfactory reaction to the virtual assistant, prompting the virtual assistant to modify the feedback for a work-related context.

By way of a non-limiting example, in FIG. 10, conversation event 1000 may be indicative of a reaction of user 102 to a virtual assistant, e.g., implemented as software executed on remote processing system 450 (see FIG. 4). For example, in response to receiving a suggestion from the virtual assistant to purchase a home in a more expensive neighborhood, user 102 may react by requesting loan options using non-vocalized speech. At least one processor may provide electronic output 1002 to the virtual assistant for adjusting a communication manner of the virtual assistant with user 102. For instance, the virtual assistant may determine that, based on the content of electronic output 1002, a response to the request for loan options should be displayed as text on mobile communications device 120, instead of played as audio via speaker 404.

In some disclosed embodiments, at least one sensor is configured to detect neurological activity of the individual from at least one cranial nerve and to determine the substance, at least in part, from the neurological activity associated with the at least one cranial nerve. Cranial nerves are nerves originating in the human brain and/or brainstem for transmitting sensory and/or motor information between the brain and portions of the head, neck, and/or torso. Neurological activity refers to electrical and/or chemical processes that occur within the nervous system, and may include communication between neurons. A sensor configured to detect neurological activity of the individual from at least one cranial nerve refers to a sensor (as described elsewhere herein) for sensing neurological activity caused by one or more cranial nerves. Such activity may include facial skin micromovements caused by non-vocalized speech. A sensor for detecting such neurological activity may include one or more of a light sensitive sensor, an imaging sensor, a phase detector, a MEMS senor, a wavemeter, a spectrometer, a spectrophotometer, a homodyne detector, and/or a heterodyne detector. To determine the substance, at least in part, from the neurological activity associated with the at least one cranial nerve refers to using the sensed neurological activity to identify the core content and/or essence of the conversation. For example, at least one processor may associate a particular neurological activity (e.g., a smile) with a friendly greeting and may determine the substance of the conversation as a meeting between friends based on the particular neurological activity. As another example, at least one processor may associate another particular neurological activity (e.g., an anxious facial expression) with feeling of being lost, and may determine the substance of the conversation as a request for directions.

By way of a non-limiting example, in FIG. 10, at least one sensor (e.g., optical sensing unit 116) may detect neurological activity of user 102 from at least one cranial nerve (e.g., cranial nerve V or with cranial nerve VII associated with subcutaneous tissue on the face of user 102) and determine the substance of conversation event 1000, at least in part, from the neurological activity associated with the at least one cranial nerve.

Some disclosed embodiments provide a system for using facial recognition to detect when someone has finished speaking (end-pointing). An end-point may indicate when an expression is completed. Difficulties may arise in determining when a user has finished speaking because pauses following speaking may vary depending on the context. For example, individuals may respond to simple questions (e.g., yes or no questions) faster than to questions demanding lengthier responses (e.g., including several words or more). Thus, merely setting a uniform time threshold for pauses, regardless of context, may cause unnecessary delays for simple phrases (e.g., yes or no), and/or may cut off a user uttering a longer expression before they have finished speaking.

Signals associated with facial recognition (e.g., facial skin micromovements) may be used to improve accuracy for determining an end-point. For example, some expressions of the mouth and/or eye gaze (e.g., eyes gazing upwards and/or an open mouth) may indicate that an individual is pausing mid-sentence, whereas other facial expressions (e.g., eyes gazing forwards and/or down, and/or closing of the mouth) may indicate that the individual has finished speaking. Embodiments are disclosed for using facial expression technology, such as a wearable system for facilitating silent conversations, may aid in detecting end-points. For example, the wearable system for facilitating silent conversations disclosed herein may use signals associated with eye gaze and/or mouth position and/or expression to determine when a pause in vocalized and/or non-vocalized speech corresponds to an end-point, and when the pause is not an end-point (e.g., an interlude in an incomplete expression). In this manner, a wearable system for facilitating silent conversations may improve responses to pauses, e.g., by responding more quickly to very short utterances, and by waiting when the wearable system determines that the individual has not finished speaking. Consequently, interactions between humans and Voice User Interfaces (VUIs) may improve, e.g., by becoming more fluid and natural and more accurately simulating human interactions. Using the wearable system disclosed herein may reduce misinterpretation of pauses by avoiding unnecessary delays to quick responses, and avoiding interrupting incomplete speech.

Another aspect of conversations may include overlap. Overlap refers to situations where multiple user intents and/or conversational threads occur simultaneously and/or in close succession. Overlap may pose challenges to Natural Language Understand (NLU) systems attempting to correctly interpret and/or respond to associated communications. For example, overlap may occur when one person is speaking, and another person demonstrates “active listening” by periodically making utterances and/or saying words that indicate to the speaker they are listening and engaged (e.g. “uh huh”). For instance, if a first party to a conversation is telling a story about a scary or upsetting situation, and a second party to the conversation says, “oh no!,” the second party may not be interrupting the first party, but may rather be actively listening to the first party and providing constructive feedback. Distinguishing verbal expressions associated with active listening from interruptions may be challenging. However, a system facilitating silent speech may use signals associate with facial skin micromovements to distinguish when an utterance is associated with active listening as opposed to an interruption. In some embodiments, detection and analysis of facial skin micromovements may be used in combination with Natural Language Understand (NLU) to improve accuracy for distinguishing overlap associated with active listening as opposed to verbal interruptions to conversations. For example, at least one processor may distinguish an expression associated with active listening versus an expression associated with an interruption based on facial expressions of the listener and/or the speaker, a context of the conversation, the identities of the listener and/or speaker, attributes of the expression (e.g., the length, volume, choice of words included in the expression) and/or any other information that may be used to distinguish an expression associated with active listening from an expression associated with an interruption. In some embodiments, at least one processor may user artificial intelligence to distinguish between an expression associated with active listening from an expression associated with an interruption.

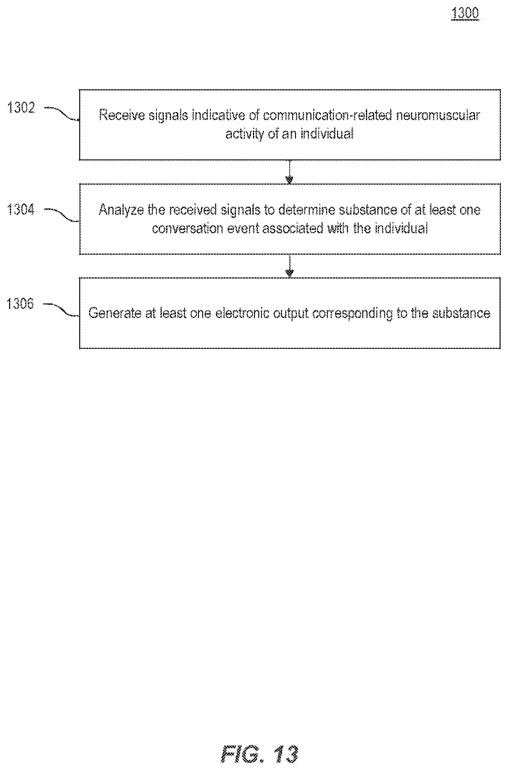

FIG. 13 is a flowchart of example process 1300 for facilitating silent conversations, consistent with embodiments of the present disclosure. In some embodiments, process 1300 may be performed by at least one processor (e.g., processing device 400 and/or processing device 460 in FIG. 4) to perform operations or functions described herein. In some embodiments, some aspects of process 1300 may be implemented as software (e.g., program codes or instructions) that are stored in a memory (e.g., memory device 402 and/or memory device 466) or a non-transitory computer readable medium. In some embodiments, some aspects of process 1300 may be implemented as hardware (e.g., a specific-purpose circuit). In some embodiments, process 1300 may be implemented as a combination of software and hardware.

Process 1300 may include a step 1302 of receiving signals indicative of communication-related neuromuscular activity of an individual. By way of a non-limiting example, in FIG. 10, at least one processor (e.g., processing device 400 and/or processing device 460 in FIG. 4) may receive signals (e.g., light reflections 300) indicative of communication-related neuromuscular activity of user 102.

Process 1300 may include a step 1302 of analyzing the received signals to determine substance of at least one conversation event associated with the individual. By way of a non-limiting example, in FIG. 10, at least one processor (e.g., processing device 400 and/or processing device 460 in FIG. 4) may analyze the received signals to determine substance of at least one conversation event 1000 associated with the user 102.

Process 1300 may include a step 1302 of generating at least one electronic output corresponding to the substance. By way of a non-limiting example, in FIG. 10, at least one processor (e.g., processing device 400 and/or processing device 460 in FIG. 4) may generate at least one electronic output 1002 corresponding to the substance.

Various example embodiments of speech detection technology are articulated below in the form of clauses. It is to be understood the term “technology” refers equally to systems, methods, and non-transitory computer readable media:

Examples of inventive concepts are contained in the following clauses which are an integral part of this disclosure:
Clause 1. A wearable system for facilitating silent conversations, the wearable system comprising: a housing configured to be worn on a head of an individual; at least one sensor incorporated with the housing and configured to output signals indicative of communication-related neuromuscular activity of the individual; and at least one processor configured to: receive the signals; analyze the received signals to determine substance of at least one conversation event associated with the individual; and generate at least one electronic output corresponding to the substance.
Clause 2. The wearable system of clause 1, wherein the at least one conversation event includes a first conversation event during a first time period and involving a first topic, and a second subsequent conversation event during a second time period and involving a second topic, wherein the received signals associated with the first conversation event constitute first signals, wherein the at least one processor is further configured to receive, during the subsequent second time interval, second signals representing speech on the second topic, and wherein the at least one electronic output includes, following the second subsequent conversation event a reminder of the first topic determined based on the first signals.
Clause 3. The wearable system of any of clauses 1-2, wherein the at least one of the first conversation event and the second subsequent conversation event involves silent speech and wherein at least one of the first signals and the second signals capture the silent speech.
Clause 4. The wearable system of any of clauses 1-3, wherein both the first conversation event and the second subsequent conversation event involve silent speech and wherein both the first signals and the second signals capture the silent speech from both the first conversation event and the second subsequent conversation event.
Clause 5. The wearable system of any of clauses 1-4, wherein the at least one processor is further configured to receive input from the individual, and based on the input, identify an intent of the individual to return to the first topic.
Clause 6. The wearable system of any of clauses 1-5, wherein the reminder includes at least one of a summary of a non-vocalized speech on the first topic, a recitation of a portion of a non-vocalized speech on the first topic, or a detail related to the first time period.
Clause 7. The wearable system of any of clauses 1-6, wherein the electronic output includes a private presentation of the first topic delivered to the individual.
Clause 8. The wearable system of any of clauses 1-7, wherein the at least one processor is further configured to determine from the at least one conversation event a personal speaking style of the individual and to audibly present to the individual the electronic output in a manner corresponding to the determined personal speaking style.
Clause 9. The wearable system of any of clauses 1-8, wherein the electronic output includes a response to a query presented in a manner mimicking an aspect of the determined personal speaking style.
Clause 10. The wearable system of any of clauses 1-9, wherein the at least one processor is further configured to determine a context for the query, and wherein the manner in which the response is presented is determined based on the determined personal speaking style and the determined context. Clause 11. The wearable system of any of clauses 1-10, wherein the aspect of the personal speaking style includes at least one of a typical speech cadence, atypical speech tone, a typical speech intonation, or atypical voice volume.
Clause 12. The wearable system of any of clauses 1-11, wherein the at least one conversation event involves a query to a virtual assistant and a pause during an articulation of the query, and wherein the at least one processor is configured to determine whether the pause is attributable to articulation delay or query completion.
Clause 13. The wearable system of any of clauses 1-12, wherein when the at least one processor determines that the pause is attributable to an articulation delay, the at least one processor is configured to withhold transmission of the query to the virtual assistant.
Clause 14. The wearable system of any of clauses 1-13, wherein when the at least one processor determines that the pause is attributable to an articulation delay, the at least one processor is configured to send an indication to the virtual assistant that the query is incomplete.
Clause 15. The wearable system of any of clauses 1-14, wherein when the at least one processor determines that the pause is attributable to query completion, the at least one processor is configured to send the query to the virtual assistant.
Clause 16. The wearable system of any of clauses 1-15, wherein the at least one processor is further configured to determine a conversation context, and to determine a cause of the pause from the determined conversation context.
Clause 17. The wearable system of any of clauses 1-16, wherein the at least one conversation event is indicative of turn-taking dynamics between the individual and a participant, and the electronic output by the least one processor reflects the turn-taking dynamics.
Clause 18. The wearable system of any of clauses 1-17, wherein the participant is another individual or a large language model.
Clause 19. The wearable system of any of clauses 1-18, wherein the at least one conversation event is indicative of a reaction of the individual to a virtual assistant, and the at least one processor is further configured to provide the electronic output to the virtual assistant for adjusting a communication manner of the virtual assistant with the individual.
Clause 20. The wearable system of any of clauses 1-19, where the at least one sensor is configured to detect neurological activity of the individual from at least one cranial nerve and to determine the substance, at least in part, from the neurological activity associated with the at least one cranial nerve.

Disclosed embodiments may include any one of the following bullet-pointed features alone or in combination with one or more other bullet-pointed features, whether implemented as a system and/or method, by at least one processor or circuitry, and/or stored as executable instructions on non-transitory computer readable media or computer readable media.
a wearable system for facilitating silent conversations;
a housing configured to be worn on a head of an individual;
at least one sensor incorporated with a housing and configured to output signals indicative of communication-related neuromuscular activity of an individual;
at least one processor configured to;
receive the signals;
analyze received signals to determine substance of at least one conversation event associated with an individual;
generate at least one electronic output corresponding to a substance of at least one conversation event;
at least one conversation event includes a first conversation event during a first time period and involving a first topic, and a second subsequent conversation event during a second time period and involving a second topic;
received signals associated with a first conversation event constitute first signals;
receive, during a subsequent second time interval, second signals representing speech on a second topic;
at least one electronic output includes, following a second subsequent conversation event a reminder of a first topic determined based on first signals;
at least one of a first conversation event and a second subsequent conversation event involves silent speech;
at least one of first signals and second signals capture silent speech;
both a first conversation event and a second subsequent conversation event involve silent speech;
both first signals and second signals capture silent speech from both a first conversation event and a second subsequent conversation event;
receive input from an individual;
based on an input, identify an intent of an individual to return to a first topic;
a reminder includes at least one of a summary of a non-vocalized speech on a first topic, a recitation of a portion of a non-vocalized speech on a first topic, or a detail related to a first time period;
an electronic output includes a private presentation of a first topic delivered to an individual;
determine from at least one conversation event a personal speaking style of an individual and to audibly present to the individual an electronic output in a manner corresponding to the determined personal speaking style;
an electronic output includes a response to a query presented in a manner mimicking an aspect of a determined personal speaking style;
determine a context for a query;
a manner in which a response is presented is determined based on a determined personal speaking style and a determined context;
an aspect of a personal speaking style includes at least one of a typical speech cadence, a typical speech tone, a typical speech intonation, or a typical voice volume;
at least one conversation event involves a query to a virtual assistant and a pause during an articulation of the query;
determine whether a pause is attributable to articulation delay or query completion;
determine that a pause is attributable to an articulation delay;
withhold transmission of a query to a virtual assistant;
send an indication to a virtual assistant that a query is incomplete.
determine that a pause is attributable to query completion, the at least one processor is configured to send a query to a virtual assistant;
determine a conversation context;
determine a cause of a pause from a determined conversation context;
at least one conversation event is indicative of turn-taking dynamics between an individual and a participant;
an electronic output by least one processor reflects turn-taking dynamics;
a participant is another individual or a large language model.
at least one conversation event is indicative of a reaction of an individual to a virtual assistant;
provide an electronic output to a virtual assistant for adjusting a communication manner of the virtual assistant with an individual.
detect neurological activity of an individual from at least one cranial nerve;
determine a substance of a conversation event, at least in part, from neurological activity associated with at least one cranial nerve.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet. The computing system can include clients and servers. A client and server are generally remote from each other and typically interact through a communication network. The relationship of client and server arises by virtue of computer programs running on the respective computers and having a client-server relationship to each other.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above-described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units can be combined as one module or unit, and each of the above-described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof. And other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

1. A wearable system for facilitating silent conversations, the wearable system comprising:
a housing configured to be worn on a head of an individual;
at least one sensor incorporated with the housing and configured to output signals indicative of communication-related neuromuscular activity of the individual; and
at least one processor configured to:
receive the signals;
analyze the received signals to determine substance of at least one conversation event associated with the individual; and
generate at least one electronic output corresponding to the substance.

2. The wearable system of claim 1, wherein the at least one conversation event includes a first conversation event during a first time period and involving a first topic, and a second subsequent conversation event during a second time period and involving a second topic, wherein the received signals associated with the first conversation event constitute first signals, wherein the at least one processor is further configured to receive, during the subsequent second time interval, second signals representing speech on the second topic, and wherein the at least one electronic output includes, following the second subsequent conversation event a reminder of the first topic determined based on the first signals.

3. The wearable system of claim 2, wherein the at least one of the first conversation event and the second subsequent conversation event involves silent speech and wherein at least one of the first signals and the second signals capture the silent speech.

4. The wearable system of claim 2, wherein both the first conversation event and the second subsequent conversation event involve silent speech and wherein both the first signals and the second signals capture the silent speech from both the first conversation event and the second subsequent conversation event.

5. The wearable system of claim 2, wherein the at least one processor is further configured to receive input from the individual, and based on the input, identify an intent of the individual to return to the first topic.

6. The wearable system of claim 2, wherein the reminder includes at least one of a summary of a non-vocalized speech on the first topic, a recitation of a portion of a non-vocalized speech on the first topic, or a detail related to the first time period.

7. The wearable system of claim 2, wherein the electronic output includes a private presentation of the first topic delivered to the individual.

8. The wearable system of claim 1, wherein the at least one processor is further configured to determine from the at least one conversation event a personal speaking style of the individual and to audibly present to the individual the electronic output in a manner corresponding to the determined personal speaking style.

9. The wearable system of claim 8, wherein the electronic output includes a response to a query presented in a manner mimicking an aspect of the determined personal speaking style.

10. The wearable system of claim 9, wherein the at least one processor is further configured to determine a context for the query, and wherein the manner in which the response is presented is determined based on the determined personal speaking style and the determined context.

11. The wearable system of claim 9, wherein the aspect of the personal speaking style includes at least one of a typical speech cadence, a typical speech tone, a typical speech intonation, or a typical voice volume.

12. The wearable system of claim 1, wherein the at least one conversation event involves a query to a virtual assistant and a pause during an articulation of the query, and wherein the at least one processor is configured to determine whether the pause is attributable to articulation delay or query completion.

13. The wearable system of claim 12, wherein when the at least one processor determines that the pause is attributable to an articulation delay, the at least one processor is configured to withhold transmission of the query to the virtual assistant.

14. The wearable system of claim 12, wherein when the at least one processor determines that the pause is attributable to an articulation delay, the at least one processor is configured to send an indication to the virtual assistant that the query is incomplete.

15. The wearable system of claim 12, wherein when the at least one processor determines that the pause is attributable to query completion, the at least one processor is configured to send the query to the virtual assistant.

16. The wearable system of claim 12, wherein the at least one processor is further configured to determine a conversation context, and to determine a cause of the pause from the determined conversation context.

17. The wearable system of claim 1, wherein the at least one conversation event is indicative of turn-taking dynamics between the individual and a participant, and the electronic output by the least one processor reflects the turn-taking dynamics.

18. The wearable system of claim 17, wherein the participant is another individual or a large language model.

19. The wearable system of claim 1, wherein the at least one conversation event is indicative of a reaction of the individual to a virtual assistant, and the at least one processor is further configured to provide the electronic output to the virtual assistant for adjusting a communication manner of the virtual assistant with the individual.

20. The wearable system of claim 1, wherein the at least one sensor is configured to detect neurological activity of the individual from at least one cranial nerve and to determine the substance, at least in part, from the neurological activity associated with the at least one cranial nerve.
